(19) United States
(12) Patent Application Publication
(10) Pub. No.: US 2026/0205269 A1
(43) Pub. Date: Jul. 16, 2026

(54) SYSTEM AND METHOD FOR MANAGING ENCRYPTED DATA ACCESS AND LIFECYCLE

(71) Applicant: Government Employees Insurance Company (GEICO), Chevy Chase, MD (US)

(72) Inventors: Michael J. Chan, San Jose, CA (US); Derek Chamorro, Austin, TX (US); William Ratner, Chesapeake, VA (US); Srikanth Akurati, San Jose, CA (US); Vishal Parikh, San Jose, CA (US); Dipak Manharlal Jani, Glen Allen, VA (US)

(73) Assignee: Government Employees Insurance Company (GEICO), Chevy Chase, MD (US)

(21) Appl. No.: 19/448,963

(22) Filed: Jan. 14, 2026

Related U.S. Application Data
(60) Provisional application No. 63/745,119, filed on Jan. 14, 2025.

(51) Int. Cl. H04L 9/08; G06F 21/62; H04L 9/40

(52) U.S. Cl. CPC H04L 9/0822; G06F 21/6218; H04L 63/1425

(57) ABSTRACT

Provided are systems and methods for managing access to encrypted data used by applications. The system includes a processor configured with program code stored in memory for a key management engine and a cryptographic tracking engine. The cryptographic tracking engine will cause the processor to generate a tracking token for a data payload with a cryptographic key identifier and a data context policy reference; store the tracking token in a tracking token database; receive a request from the key management engine to encrypt the data payload based on a request from a first application servicer; and permit the key management engine to encrypt the data payload for the first application servicer based on determining that the first application servicer fulfills the data context policy. The key management engine will cause the processor to encrypt the data payload based on a response from the cryptographic tracking engine.

### CROSS-REFERENCE TO RELATED APPLICATION

This Application for Patent claims the benefit of U.S. Provisional Patent Application No. 63/745,119 filed on Jan. 14, 2025, and is incorporated by reference herein in its entirety.

### FIELD

The subject matter disclosed relates generally to computer implementations of managing access to encrypted data and managing a lifecycle of encrypted data and/or cryptographic keys embedded in a computer system, and, in some embodiments, to methods, systems, and non-transitory computer readable mediums encoded with program code for managing access to encrypted data used by application services.

### BACKGROUND INFORMATION

In many instances, computer systems may fail to avoid being “amnesic” to various means, conditions, and/or contexts of the computer system relating to how cryptographic keys are used to protect data used and/or shared among applications and services within the computer system. Such failures to manage use and sharing of data (e.g., encrypted data) among applications and services as well as an application's or service's access to cryptographic keys may result in loss of secure data or other data security problems.

A computer system may handle requests for cryptographic keys and may use sensitive data without managing or tracking which applications and/or services request the cryptographic keys or use and/or share the sensitive data. The computer systems may also not track a longevity of the cryptographic keys used within the computer system. If common vulnerabilities and exposures (CVE) exist in applications and/or services in the computer system, sources of cryptographic key generation, cryptographic key usage, and usage of sensitive data may be vulnerable. Cryptographic keys and sensitive data should be managed and tracked such that security of the sensitive data can be ensured and enhanced.

### SUMMARY

Embodiments may relate to a computing system for managing access to encrypted data used by application services. The system can include a processor configured with program code stored in memory for one or more cryptographic permit logic engines providing services. The program code for the one or more cryptographic permit logic engines can include program code for a key management engine and a cryptographic tracking engine. The program code for the cryptographic tracking engine, when executed by the processor, can cause the processor to generate a tracking token for a data payload having a data structure which can associate the data payload with a cryptographic key identifier. The tracking token for a data payload having a data structure can also associate the data payload with a data context policy reference to a data context policy which defines at least one conditional attribute for an application servicer interacting with the data payload. The tracking token for a data payload having a data structure can also associate the data payload with a validity condition comprising at least one of a start time, an expiration time, a validity interval, or a lifecycle state for the cryptographic key identifier. The program code for the cryptographic tracking engine, when executed by the processor, can cause the processor to store the tracking token in a tracking token database. The program code for the cryptographic tracking engine, when executed by the processor, can cause the processor to receive a request from the key management engine to encrypt the data payload based on a request from a first application servicer providing a first service. The program code for the cryptographic tracking engine, when executed by the processor, can cause the processor to scan the first application servicer to identify security attributes of the first application servicer. The program code for the cryptographic tracking engine, when executed by the processor, can cause the processor to transmit a signal to the key management engine permitting the key management engine to encrypt the data payload for the first application servicer based on determining that the first application servicer fulfills the at least one conditional attribute defined by the data context policy included in the tracking token. In some aspects, the program code for the cryptographic tracking engine, when executed by the processor, can cause the processor to transmit a signal to the key management engine permitting the key management engine to encrypt the data payload for the first application servicer based on determining that the first application servicer fulfills the at least one conditional attribute defined by the data context policy included in the tracking token and that the validity condition is satisfied. The program code for the key management engine, when executed, can cause the processor to encrypt the data payload based on a response from the cryptographic tracking engine indicating the key management engine is permitted to encrypt the data payload.

Embodiments may relate to a computer-implemented method for managing access to encrypted data. The method may include tagging a data payload with a data classification and a data type. The method may also include initializing a tracking token data structure with a tracking token containing a data payload and a data context policy reference. The data context policy reference can indicate a data context policy which defines at least one conditional attribute for an application service to interact with the data payload. The method may include storing the tracking token in a tracking token database accessible by a key management engine. The method may also include receiving a request from a first application servicer to transmit the data payload to a second application servicer. The method may include querying, by the key management engine, the tracking token database to determine that the second application servicer satisfies the data context policy. The method may also include transmitting the data payload from the first application servicer to the second application servicer when the second application servicer satisfies the data context policy.

### BRIEF DESCRIPTION OF THE DRAWINGS

Other objects and advantages of the present disclosure will become apparent to those skilled in the art upon reading the following detailed description of exemplary embodiments, in conjunction with the accompanying drawings, in which like reference numerals have been used to designate like elements, and in which:

FIG. 1 is a diagram of an exemplary system configuration for managing access to encrypted data used by application services as disclosed herein.

FIG. 2 is a flow diagram of an exemplary method for managing access to encrypted data used by application services as disclosed herein.

FIG. 3 is a diagram of example data types and/or data classifications that can be tagged and/or scanned for vulnerabilities as disclosed herein.

FIG. 4 is a diagram of an exemplary architecture for a computer system and/or network in which exemplary system configurations for managing access to encrypted data used by application services can be implemented as disclosed herein.

FIG. 5 is a sequence diagram for an application servicer for obtaining a signed tracking token as disclosed herein.

FIG. 6 is a sequence diagram for an application servicer for requesting encryption of a data payload as disclosed herein.

FIG. 7 is a sequence diagram for a first application servicer for interacting with and/or sharing a data payload with a second application servicer as disclosed herein.

FIG. 8 is an exemplary data structure for a tracking token including a data payload and a cryptographic key identifier as disclosed herein.

FIG. 9 is another exemplary data structure for a tracking token including a data payload and a cryptographic key identifier as disclosed herein.

FIG. 10 is another exemplary data structure for a tracking token including a data payload and a cryptographic key identifier as disclosed herein.

FIG. 11 is a schematic diagram of example components of one or more systems and/or devices of FIG. 1 and/or FIG. 4 as disclosed herein.

### DETAILED DESCRIPTION

Embodiments disclosed herein present a novel approach to secure data handling and encryption integrity within an organization and/or computing system. There are limitations of current Key Management Systems (KMS) in maintaining consistent protection of encrypted data as it traverses different services and applications within a computing system. Embodiments disclosed herein include a policy engine (e.g., cryptographic tracking engine 102) that implements a “tag and trace” mechanism for encrypted data. The present disclosure describes an architecture of the policy engine, integration of the policy engine with existing KMS infrastructures, and implementation of the policy engine in large-scale computing systems.

In accordance with exemplary embodiments, computing systems having specially configured processors can be used for managing access to encrypted data used by application services. According to some embodiments, computing systems with a specially configured processor for managing access to encrypted data used by application services can enhance security of a computing system and provide protection of sensitive data by tracking and tagging encrypted data that is shared among various applications and/or services executing within the computing system. Such embodiments can improve security and protection of sensitive data by providing various cryptographic mechanism, such as a signed configuration file (provides authorized and canonized configurations), a signed service configuration (provides proper provisioning of credentials), novel transmission and/or tracking tokens (providing signed payloads, e.g. for authorized access, tracing, etc.), and smart contracts (providing authorized execution—which can allow for binding of application logic with infrastructure service tokens, etc.), and richer syntax to improve interoperability with existing computing systems (which can allow for extending, encapsulating, and binding other formats, e.g. X509, etc.).

Embodiments disclosed herein can allow for data, secrets/trust management, system parameters, profiles of service/machine state (attestation) to be portable and interoperable - all under a single cryptographic data structure. Such embodiments can ensure secure contextual usage of data payloads and cryptographic keys such that a lifecycle of cryptographic keys can be controlled and embedded within a particular computing system. Such embodiments can enhance data payload-cryptographic key association, improving message integrity and security of cryptographic key distribution and usage among applications. Thus, embodiments can improve a computing system's tracking and management of conditions and/or contexts of how cryptographic keys are securing data and what data is being secured by cryptographic keys, such that systems can keep an inventory, react and intervene (or communicate and coordinate) to ensure that sensitive data is appropriately protected. Embodiments can also track the usage and longevity of cryptographic keys, improving upon existing formats such as X509. Embodiments disclosed herein can provide a data structure for tokenization that allows computing systems to track and trace each of sensitive data, a cryptographic key, and a system involved in the sharing and/or usage of the sensitive data. For instance, some embodiments can detect a CVE within a cryptographic algorithm and/or cryptographic tools or facilities (e.g., Heartbleed in OpenSSL). In this instance, there may be limited methods to track and/or trace the stakeholders and/or applications that use sensitive data and limited methods to create trusted automated intervention. However, embodiments disclosed herein can remedy this by providing a tracking token data structure to allow for tracking and/or tracing the stakeholders and/or application usage of the sensitive data and embodiments can provide methods for trusted automated intervention where required. In addition, embodiments disclosed herein can provide assurance and/or tracking of a source of cryptographic key generation, such that sources of cryptographic keys can be known and tracked by the computing system.

In this way, embodiments can improve upon existing computing systems and services that currently operate in an insecure way, exposing sensitive data to potential security breaches. Embodiments can improve upon security of computing systems and sensitive data by tracking sources, identities, data, and cryptographic keys, such that computing systems are contextually aware and secure (e.g., non-amnesiac, non-nescient system). Embodiments can reduce the use and requirement of storage resources, such that embodiments make it possible to obviate certain storage of the data and pass tracking tokens that relate to the data and cryptographic keys used.

Embodiments disclosed herein provide a tracking token data structure that embeds an intent attribute to determine what sensitive data is being shared between applications and/or services and why such sensitive data is being shared. The tracking token data structure can include a cryptographic mechanism to specify how the sensitive data may be protected. The tracking tokens generated based on the tracking token data structure can ensure that computing systems are not amnesic and are provided with links and references such that the computing system can track where and when (and how long) the sensitive data is encrypted, shared, and/or used among applications and/or services within the computing system.

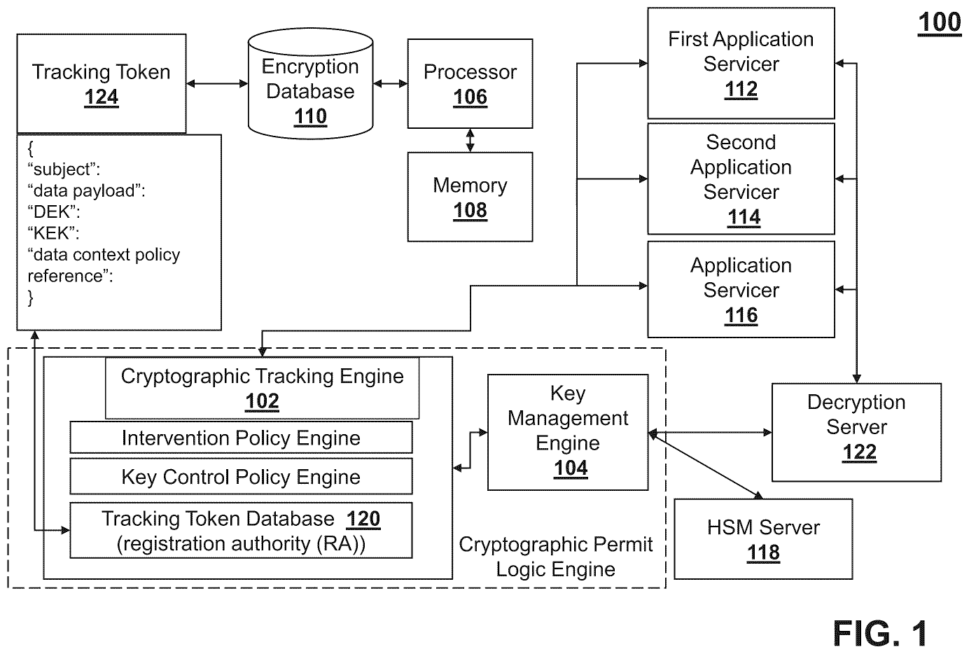

FIG. 1 shows a diagram of an exemplary system configuration for managing access to encrypted data used by application services as disclosed herein. The various components of FIG. 1 can be implemented in and/or processed by a specially configured processor (e.g., a CPU) and/or on any number of specially configured distributed processors (e.g., a distributed and/or decentralized computing system) coupled with memory and connected via a communications network. Each of the components shown in FIG. 1 are described in the context of an exemplary embodiment.

As shown in FIG. 1, embodiments relate to a cryptographic tracking system 100 configured for managing access to encrypted data used by application services. In some embodiments, cryptographic tracking system 100 can be specially configured for managing access to encrypted data used by application services within a computing network. Cryptographic tracking system 100 can include cryptographic tracking engine 102, key management engine 104, processor 106, memory 108, database 110, first application servicer 112, second application servicer 114, application servicer 116, hardware security module (HSM) server 118, tracking token database 120, decryption server 122, and tracking token 124.

Cryptographic tracking system 100 can be configured for managing access to encrypted data used by application services. As disclosed herein, cryptographic tracking system 100 can be configured to manage access to encrypted data using at least one tracking token 124. As disclosed herein, tracking token 124 may include a data object including a data structure, wherein the data object includes at least a data payload and a cryptographic key, and/or references to a data payload, a cryptographic key, and a data context policy.

Cryptographic tracking system 100 can include a processor configured with program code stored in memory for one or more cryptographic permit logic engines providing services including a key management engine and a cryptographic tracking engine. For example, cryptographic tracking system 100 can include cryptographic tracking engine 102 and key management engine 104 which can include program code executable by processor 106.

In some embodiments, the program code for the one or more cryptographic permit logic engines, when executed, will cause the processor to create a permit (e.g., tracking token 124) for a protected data object. The permit may include a machine-readable data structure (e.g., data structure 800) generated during enrollment of the protected data object into a data enrollment registry.

In some embodiments, the machine-readable data structure may be generated in accordance with a template. The template may be selected from a set of templates maintained by a template registry under registry authority (RA) governance (e.g., included in tracking token database 120). Each template may define a schema for the data structure used to generate the permit (tracking token), including one or more required fields. In some aspects, the permit may be generated as an instance of the selected template by populating the fields of the schema with values corresponding to a protected data object and an associated protection context. In some aspects, the templates may define different schemas and/or different sets of required fields.

In some embodiments, the program code for the cryptographic tracking engine, when executed, will cause the processor to generate a tracking token for a data payload having a data structure which associates the data payload with a cryptographic key identifier, and with a data context policy reference to a data context policy which defines at least one conditional attribute for an application servicer interacting with the data payload. For example, processor 106 may execute program code for cryptographic tracking engine 102 to generate tracking token 124, where tracking token 124 includes a reference to a data payload. Tracking token 124 can be generated based on a specific data structure for the tracking tokens. Tracking token 124 can also include a cryptographic key identifier, or a reference to a cryptographic key that is associated with the data payload (e.g., used to encrypt and/or decrypt the data payload). Tracking token 124 can also include a reference to a data context policy, such that the reference points to a stored data context policy including at least one conditional attribute that can be checked and/or monitored based on application servicers being executed within a computing system. In this way, the data payload, cryptographic keys, and data context policy can be said to be “entangled” based on their relationships bound within a tracking token.

In some embodiments, the program code for the cryptographic tracking engine, when executed, will cause the processor to store the tracking token in a tracking token database. For example, cryptographic tracking system 100 may store tracking token 124 in tracking token database 120. Tracking token database 120 may include a database storing plural tracking token data objects conforming to the tracking token data structure.

In some embodiments, the program code for the cryptographic tracking engine, when executed, will cause the processor to receive a request from the key management engine to encrypt the data payload based on a request from a first application servicer providing a first service. For example, key management engine 104 can transmit a request to cryptographic tracking engine 102 requesting permission to encrypt and/or decrypt a data payload from either first application servicer 112 or second application servicer 114. Cryptographic tracking engine 102 can query tracking database 120 for tracking token 124 associated with either first application servicer 112 or second application servicer 114 to confirm that either first application servicer 112 or second application servicer 114 is permitted to encrypt and/or decrypt the data payload.

In some embodiments, the program code for the cryptographic tracking engine, when executed, will cause the processor to transmit a signal to the key management engine permitting the key management engine to encrypt the data payload for the first application servicer based on determining that the first application servicer fulfills the at least one conditional attribute defined by the data context policy included in the tracking token. For example, cryptographic tracking engine 102 may transmit a response and/or message to key management engine 104 indicating that key management engine 104 is permitted to encrypt and/or decrypt the data payload for either first application servicer 112 or second application servicer 114, based on information and/or references included in tracking token 124.

In some embodiments, the program code for the cryptographic tracking engine, when executed, will cause the processor to scan the first application servicer to identify security attributes of the first application servicer. For example, cryptographic tracking engine 102 can scan first application servicer 112 to identify security attributes of first application servicer 112, such as first application servicer's 112 virus and/or vulnerability status, a type of application, and other attributes that can be used to determine that first application servicer meets a conditional attribute of a data context policy for a tracking token.

The tracking token can keep a “state” of a context and/or a relationship between a key (e.g., an encryption key) and data that is encrypted using the key in relation to the system using the encrypted data and/or encrypted data payload. In this way, the tracking token is said to store the context of the key-data relationship, thus “entangling” the key and the data such that a data context policy (e.g., rules and conditions) for use of the encrypted data can be defined and activated to provide assurance and monitoring of encrypted data based on the contextual relationships. Thus, embodiments can provide an additional layer of security by tracking usage of encrypted data and restricting usage based on system and data context.

In some embodiments, the program code for the key management engine, when executed, will cause the processor to encrypt the data payload based on a response from the cryptographic tracking engine indicating the key management engine is permitted to encrypt the data payload. As disclosed herein, key management engine 104 can then encrypt and/or decrypt the data payload for either first application servicer 112 or second application servicer 114. In some embodiments, the information queried by cryptographic tracking engine 102 in tracking token 124 can be cached in memory 108, for example, for application servicer 116 to access at another time. This can avoid having to query tracking token database 120 again to determine whether first application servicer 112 or second application servicer 114 satisfy a data context policy and may be permitted to encrypt/decrypt/use the data payload.

Cryptographic tracking system 100 can include tracking token database 120 including storage locations configured to store tracking tokens 122. Cryptographic tracking system 100 can include processor 106 configured with program code stored in memory 108 for plural application servicers providing services, including at least key management engine 104 and cryptographic tracking engine 102, wherein the program code for cryptographic tracking engine 102, when executed by processor 106, will cause processor 106 to generate tracking token 124 for a data payload. Tracking token 124 can include a data structure which associates the data payload with a cryptographic key identifier (e.g., an identifier for a data encryption key (DEK) and/or an identifier for a key encryption key (KEK)). In some embodiments, tracking token 124 can include a data structure which associates the data payload and/or the cryptographic key identifier with a data context policy reference to a data context policy. In some embodiments, the data context policy can define at least one conditional attribute for an application servicer interacting with the data payload.

In some embodiments, the at least one conditional attribute can include a security attribute pertaining to an application servicer, where the application servicer must fulfill the security attribute in order to satisfy the data context policy associated with tracking token 124. For example, the at least one conditional attribute can include a known CVE of the application servicer. In this example, the application servicer may satisfy the data context policy only if the application servicer fulfills the security attribute by not including the CVE or by including a remedy to the CVE. Such a remedy can include program code and/or an implementation of the application servicer that obviates the CVE. In this way, when a CVE of the application servicer is obviated, cryptographic tracking system 100 can determine that the application servicer satisfies the data context policy and is therefore secure such that the application servicer can use and/or receive the data payload (e.g., sensitive data) and/or cryptographic keys associated with the cryptographic key identifier.

In some embodiments, the at least one conditional attribute can include any one of an application identifier, a timestamp corresponding to a time a request for encrypted data was received by the processor, and a reason for the request for encrypted data. For example, the at least one conditional attribute defined in the data context policy of a tracking token for first application servicer 112 can include an identifier for a specific version of first application servicer 112, a timestamp corresponding to a time when first application servicer 112 transmitted a request to processor 106 requesting encrypted data or a timestamp corresponding to when the request was received by processor 106, or a description corresponding to a reason for requesting the encrypted data (e.g., for authorizing a payment, and so forth). Such conditional attribute can be used to determine whether first application servicer 112 (or second application servicer 114) satisfies security requirements for requesting specific encrypted data. As a further example, cryptographic tracking engine 102 can use the key control policy engine to determine whether first application service meets a conditional attribute requiring a specific reason and/or type of application for accessing encrypted data corresponding to the data context policy. This could include requirements that first application servicer 112 is a payment application (e.g., where the encrypted data and data context policy applies to credit card information). First application servicer 112 may be denied access to the encrypted data (e.g., for failing to meet the conditional attribute of the data context policy) where first application servicer 112 is not a payment application, but is for example, a graphics rendering application, or another type of application unrelated to payments and/or payment data.

In some embodiments, cryptographic tracking system 100 (e.g., processor 106 thereof) can store tracking token 124 in tracking token database 120. In some embodiments, tracking token database 120 can be integrated with (e.g., part of) cryptographic tracking engine 102. In some embodiments, the tracking token can include any one of alternative data structures, such as but not limited to, a certificate, a digital signature, a signed identifier, single sign-on credentials, Zero-Knowledge Proof (ZPK) attributes, a signed configuration, a Kerberos ticket, and a digital contact trace. The data structure of the tracking token can reference the data context policy (e.g., stored in encryption database 110, tracking token database 120, or another database accessible by cryptographic tracking engine 102).

In some embodiments, cryptographic tracking system 100 (e.g., processor 106 thereof, when executing cryptographic tracking engine 102) can receive a request from key management engine 104 to encrypt the data payload based on a request from first application servicer 112, where first application servicer 112 can provide a first service. A service can include a specification operation for which an application servicer is programmed to perform. Examples of services can include a payment processing service, a notification service, a data service, or another service accessible by an application servicer or a user.

In some embodiments, cryptographic tracking system 100 (e.g., processor 106 thereof, when executing cryptographic tracking engine 102 and/or key management engine 104) can permit key management engine 104 to encrypt the data payload for first application servicer 112 based on determining that first application servicer 112 fulfills the at least one conditional attribute defined by the data context policy included in tracking token 124. In some embodiments, cryptographic tracking system 100 (e.g., processor 106 thereof, when executing cryptographic tracking engine 102 and/or key management engine 104) can permit key management engine 104 to decrypt the data payload for first application servicer 112 based on determining that first application servicer 112 fulfills the at least one conditional attribute defined by the data context policy included in tracking token 124.

In some embodiments, cryptographic tracking system 100 can include processor 106 configured with program code for key management engine 104, wherein the program code for key management engine 104, when executed by processor 106, can cause processor 106 to encrypt the data payload based on a response from cryptographic tracking engine 102 indicating key management engine 104 is permitted to encrypt the data payload.

In some embodiments, the program code for the cryptographic tracking engine, when executed, can cause the processor to receive a request from the first application servicer to transmit the data payload to a second application servicer providing a second service.

In some embodiments, the program code for the cryptographic tracking engine, when executed, can cause the processor to query the tracking token database to determine that a second tracking token is present in the tracking token database including a second data context policy for the second application servicer.

The program code for the cryptographic tracking engine, when executed, can cause the processor to permit the first application servicer to transmit the data payload to the second application servicer based on determining that the second application servicer fulfills the second data context policy.

In some embodiments, cryptographic tracking engine 102 can cause the processor 106 to receive a request from first application servicer 112 to transmit the data payload to second application servicer 114 providing a second service. Cryptographic tracking engine 102 can cause processor 106 to query tracking token database 120 to determine that a second tracking token is present in tracking token database 120 including a second data context policy for second application servicer. Cryptographic tracking engine 102 can cause processor 106 to permit first application servicer 112 to transmit the data payload to second application servicer 114 based on determining that second application servicer 114 fulfills the second data context policy.

In some embodiments, the program code for the cryptographic tracking engine, when executed, can cause the processor to receive a request from the first application servicer to transmit the data payload to a second application servicer providing a second service.

The program code for the cryptographic tracking engine, when executed, can cause the processor to query the tracking token database to determine that a tracking token associated with the second application servicer is not present in the tracking token database.

The program code for the cryptographic tracking engine, when executed, can cause the processor to generate a second tracking token including a second data context policy which defines at least one conditional attribute for the second application servicer to interact with the data payload.

In some embodiments, cryptographic tracking engine 102 can cause processor 106 to receive a request from first application servicer 112 to transmit the data payload to second application servicer 114 providing a second service. Cryptographic tracking engine 102 can cause processor 106 to query tracking token database 120 to determine that a tracking token associated with second application servicer 114 is not present in tracking token database 120. Cryptographic tracking engine 102 can cause processor 106 to generate a second tracking token including a second data context policy which defines at least one conditional attribute for second application servicer 114 to interact with the data payload.

In some embodiments, the program code for the cryptographic tracking engine, when executed, can cause the processor to receive a request from the first application servicer to transmit the data payload to a second application servicer providing a second service.

The program code for the cryptographic tracking engine, when executed, can cause the processor to query the tracking token database to determine that a second tracking token is present in the tracking token database including a second data context policy for the second application servicer.

The program code for the cryptographic tracking engine, when executed, can cause the processor to deny the request from the first application servicer to transmit the data payload to the second application servicer based on determining that the second application servicer does not fulfill the second data context policy.

In some embodiments, cryptographic tracking engine 102 can cause processor 106 to receive a request from first application servicer 112 to transmit the data payload to second application servicer 114 providing a second service. Cryptographic tracking engine 102 can cause processor 106 to query tracking token database 120 to determine that a second tracking token is present in tracking token database 120 including a second data context policy for second application servicer 114. Cryptographic tracking engine 102 can cause processor 106 to deny the request from first application servicer 112 to transmit the data payload to second application servicer 114 based on determining that second application servicer 114 does not fulfill the second data context policy.

In some embodiments, the program code for the cryptographic tracking engine, when executed, can cause the processor to detect a common vulnerability present within the second application servicer.

The program code for the cryptographic tracking engine, when executed, can cause the processor to suspend the second tracking token associated with the second application servicer based on detecting the common vulnerability.

In some embodiments, cryptographic tracking engine 102 can cause processor 106 to detect a common vulnerability present within second application servicer 114. Cryptographic tracking engine 102 can cause processor 106 to suspend the second tracking token associated with second application servicer 114 based on detecting the common vulnerability.

In some embodiments, the program code for the cryptographic tracking engine, when executed, can cause the processor to receive a notification indicating the common vulnerability is not present within the second application servicer.

The program code for the cryptographic tracking engine, when executed, can cause the processor to update the second tracking token in the tracking token database to remove a suspension of the second tracking token.

In some embodiments, cryptographic tracking engine 102 can cause processor 106 to receive a notification indicating the common vulnerability is not present within second application servicer 114. Cryptographic tracking engine 102 can cause processor 106 to update the second tracking token in the tracking token database to remove a suspension of the second tracking token.

In some embodiments, the program code for the cryptographic tracking engine, when executed, can cause the processor to detect the common vulnerability present within the second application servicer based on executing a vulnerability scan of the second application servicer.

In some embodiments, cryptographic tracking engine 102 can cause processor 106 to detect the common vulnerability present within second application servicer 114 based on executing a vulnerability scan of second application servicer 114.

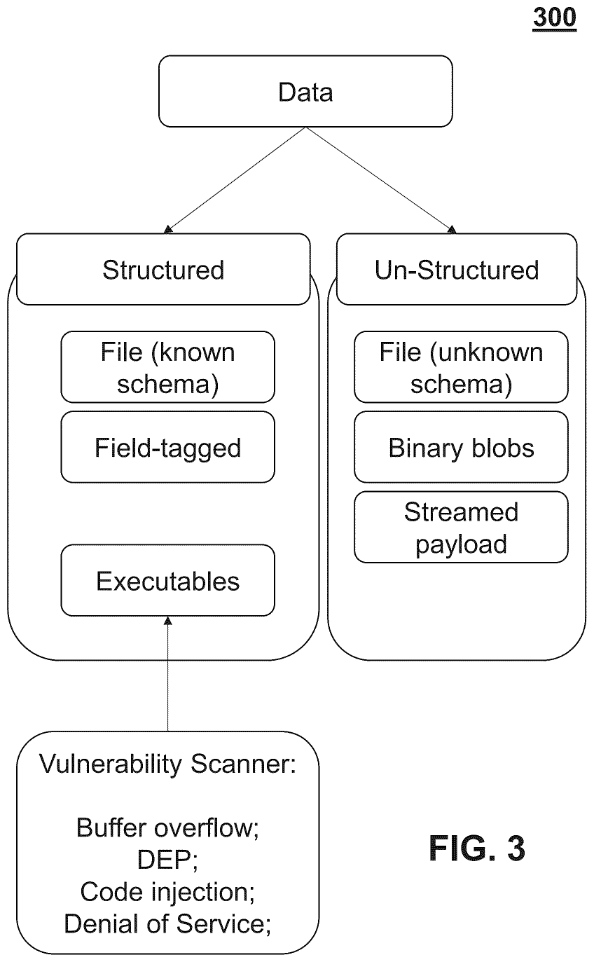

In some embodiments, the at least one conditional attribute for an application servicer and/or a cryptographic permit logic engine interacting with the data payload can be based on a tagged data type for the data payload. As used herein, a tagged data typed may include data identified with a field tag such as “html form” or “list” defining a data type of the data payload. Such tagged data types may include key-value paired data, specific forms of lists and/or linked lists (graphs, trees, etc.). Other data types may include files (e.g., known schema) such as text files, image files, audio files, data frames, portable document format (PDF) etc., binary blobs, unknown executable files, or streamed payloads (e.g., files with unknown schema). Some examples of data types that can be tagged are shown in FIG. 3.

In some embodiments, a data tag can come in a form of <data_PII> data </data_PII>, such that cryptographic tracking system 100 can sieve, identify and detect where data tags exist and what data type and/or sensitivity level of data the tags cover. Tags can assist cryptographic tracking system 100 in monitoring and processing the encrypted data, and if the encrypted data is accidentally dumped into an exception log trace, cryptographic tracking system 100 can also detect the data and therein react. Other forms of data tags can include tags for secret data, personally identifiable information (PII), or payment card industry (PCI) data.

In some embodiments, cryptographic tracking engine 102 can include an intervention policy service and a key control policy service. The intervention policy engine and/or the key control policy engine may be used as components of cryptographic tracking engine 102 to separate responsibility of cryptographic tracking engine 102 into separate components. For example, a key control policy service engine may be used to manage a lifecycle of cryptographic keys based on tracking tokens 122 associated with the cryptographic keys and data payloads, while an intervention policy service engine can be used to handle querying tracking token database 120 and updating and/or suspending existing tracking tokens 122 to control permissions of various application engines and/or cryptographic permit logic engines.

In some embodiments, cryptographic tracking engine 102 can cause processor 106 to manage a lifecycle of a cryptographic key associated with the cryptographic key identifier stored in the tracking token.

Cryptographic tracking system 100 can include cryptographic tracking engine 102, key management engine 104, processor 106, memory 108, database 110, first application servicer 112, second application servicer 114, application servicer 116, HSM server 118, tracking token database 120, and at least one tracking token 124. In some embodiments, cryptographic tracking engine can include tracking token database 120, which can store the at least one tracking token 124. Cryptographic tracking system 100 and/or cryptographic tracking engine 102 can include a computing device connected to a network. In some embodiments, cryptographic tracking system 100 can include components shown in FIG. 1 in a single computing device or computing system. Alternatively, cryptographic tracking system 100 can include components shown in FIG. 1 distributed across multiple computing devices and/or computing systems.

Cryptographic tracking system 100 can include cryptographic tracking engine 102. Cryptographic tracking engine 102 can include program code for managing access to encrypted data used by application services. For example, cryptographic tracking engine 102 can include program code for an intervention policy engine and a key control policy engine. Cryptographic tracking engine can also include tracking token database 120 to store tracking tokens 122. Cryptographic tracking engine 102 can be executed by processor 106 to generate and manage tracking tokens 122 for managing access to encrypted and/or sensitive data among application services operating within cryptographic tracking system 100.

Cryptographic tracking system 100 can include key management engine 104. In some embodiments, key management engine 104 can include program code for managing cryptographic keys within a computing system. In some embodiments, key management engine 104 may be the same as or similar to a commercial off-the-shelf key management service (KMS) used to manage cryptographic keys. It should be understood that key management engine is not limited to a commercial off-the-shelf KMS, and can include any engine and/or program code designed to manage, create, and/or share cryptographic keys for the purpose of maintaining data security and/or integrity.

Cryptographic tracking system 100 can include processor 106 (e.g., a specially configured processor, CPU, and/or the like), memory 108, and storage device 110. Processor 106 can execute software instructions (e.g., compiled program code) for cryptographic tracking engine 102, including software instructions for executing tracking token database 120, and key management engine 104.

Cryptographic tracking system 100 can include one or more computing devices including one or more processors (e.g., processor 106) configured to execute software instructions. For example, cryptographic tracking system 100 can include a desktop computer, a portable computer (e.g., laptop computer, tablet computer), a workstation, a mobile device (e.g., smartphone, cellular phone, personal digital assistant, wearable device), a server, and/or other like devices. Cryptographic tracking system 100 can include a computing device configured to communicate with one or more other computing devices over a network. Cryptographic tracking system 100 can include a group of computing devices (e.g., a group of servers) and/or other like devices. In some embodiments, cryptographic tracking system 100 can include a data storage device (e.g., database 110). Alternatively, a data storage device can be separate from cryptographic tracking system 100 and can be in communication with cryptographic tracking system 100 over a communication network.

Processor 106 can be implemented in hardware, software, or a combination of hardware and software. For example, processor 106 can include a common processor (e.g., a CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed and/or execute software instructions to perform a function. Processor 106 can be coupled to memory 108 via a data bus to transfer data between processor 106 and memory 108.

Memory 108 can include random access memory (RAM), read-only memory (ROM), and/or another type of dynamic or static storage device (e.g., flash memory, magnetic memory, optical memory, etc.) that stores information and/or software instructions for use by processor 106. Memory 108 can include a computer-readable medium and/or storage component. A computer-readable medium (e.g., a non-transitory computer-readable medium) is defined herein as a non-transitory memory device. A non-transitory memory device includes memory space located inside of a single physical storage device or memory space spread across multiple physical storage devices. In some embodiments, memory 108 can include one or more storage locations for storing data and/or data entries, such as data payloads and/or tracking tokens 122.

Software instructions can be read into memory 108 from another computer-readable medium or from another device via a communication interface with cryptographic tracking system 100. When executed, software instructions stored in memory 108 can cause processor 106 to perform one or more processes and/or functions described herein. Embodiments described herein are not limited to any specific combination of hardware circuitry and software and can include various combinations of hardware circuitry and software.

Database 110 can include random access memory (RAM), read only memory (ROM), and/or another type of dynamic or static storage device (e.g., flash memory, magnetic memory, optical memory, etc.) that stores information for use by cryptographic tracking system 100 and/or processor 106. For example, database 110 can store data payloads or other data used by first application servicer 112, second application servicer 114, and/or application servicer 116. In some embodiments, database 110 can store data payloads and/or encrypted data payloads for referencing in tracking token 124 and/or sharing among application services within cryptographic tracking system 100. In some embodiments, database 110 can include a non-transitory computer readable medium that can store information, software, and/or machine learning models related to the operation and use of cryptographic tracking system 100, cryptographic tracking engine 102, key management engine 104, and/or processor 106. For example, database 110 can include a hard disk (e.g., a magnetic disk, an optical disk, a magneto-optic disk, a solid-state disk, etc.) and/or another type of computer-readable medium.

Database 110 can include a computing device (e.g., a database device) configured to communicate with processor 106 (e.g., via one or more application servicers 112, 116, and/or 116) via a bus or a network environment. For example, database 110 can include a server, a group of servers, and/or other like devices. In some embodiments, database 110 can be associated with one or more computing devices providing interfaces such that a user and/or an application servicer can interact with database 110 via the one or more computing devices. Database 110 can be in communication with cryptographic tracking system 100 and/or processor 106 such that database 110 is separate from cryptographic tracking system 100 and/or processor 106. Alternatively, database 110 can be part (e.g., a component) of cryptographic tracking system 100 (e.g., as shown in FIG. 1).

In some embodiments, database 110 can include a device capable of storing data (e.g., a data storage device). In some embodiments, database 110 can include a collection of data (e.g., data elements, data payloads, etc.) stored and accessed by one or more computing devices and/or application servicers. Database 110 can include file system storage, cloud storage, in-memory storage, and/or the like. Database 110 can include non-volatile storage (e.g., flash memory, magnetic media), volatile storage (e.g., random access memory (RAM)), or both non-volatile and volatile storage. In some embodiments, database 110 can be hosted (e.g., stored and permitted to be accessed by other computing devices via a network environment) on a computing device separate from cryptographic tracking system 100. Database 110 can be configured to communicate with processor 106 via one or more application services and/or application servicers, such as first application servicer 112, second application servicer 114, and/or application servicer 116.

As used herein, an engine and/or application servicer (e.g., software code, software/hardware component, software application, and/or the like), a service (e.g., software service, microservice, and/or the like), or an application can refer to a loosely-coupled software application and/or a loosely-coupled software service that is designed to facilitate software reuse and high cohesion. In the microservice architecture, software services can be fine-grained having lightweight protocols. Software modules and/or services can include interfaces which are treated as a private or a public application programming interface (API). The software engine and/or software service can exist and may be reusable (e.g., portable to other software applications and/or systems without requiring changes to the module) independent of other software modules and/or software services.

Cryptographic tracking engine 102 can include a software engine (e.g., an engine invoked by processor 106 based on program code executed by processor 106) such that functionalities of cryptographic tracking engine 102 can be accessed via an application programming interface (API). In some embodiments, cryptographic tracking engine 102 can include a software engine such that cryptographic tracking engine 102 can be packaged into a single unit (e.g., a single unit of reusable program code) that can be easily deployed and/or shared. In some embodiments, cryptographic tracking engine 102 can include a combination of hardware and software (e.g., a specially configured processor to perform certain functions) such that cryptographic tracking engine 102 can perform functions and share data and/or commands with processor 106. Cryptographic tracking engine 102 can include various functions (e.g., via hardware or software) that can cause processor 106 to manipulate objects and/or data (e.g., data payloads, tracking tokens 122) to manage access to encrypted data used by application services.

As an example, cryptographic tracking engine 102 can be configured to tag a data payload with a data classification and a data type. Cryptographic tracking engine 102 can be configured to initialize tracking token 124 using a tracking token data structure. Cryptographic tracking engine 102 can store tracking token 124 in tracking token database 120. Cryptographic tracking engine 102 can receive a request from first application servicer 112 to transmit the data payload to second application servicer 114. Key management engine 104 can query tracking token database 120 to determine that second application servicer 114 satisfies the data context policy. Cryptographic tracking engine 102 can transmit the data payload from first application servicer 112 to second application servicer 114 when second application servicer 114 satisfies the data context policy.

As disclosed herein, an engine can include software, hardware, or a combination of software and hardware. As an example, where cryptographic tracking engine 102 includes a software engine, cryptographic tracking engine 102 can be configured as program code to cause processor 106 to perform various functions. Alternatively, where cryptographic tracking engine 102 includes software and hardware, cryptographic tracking engine 102 can be configured as program code and hardware (e.g., a specially configured processor) to perform various functions independent of and/or in conjunction with processor 106. In this way, cryptographic tracking engine 102 can be configured with its own hardware and/or processor for performing various functions and cryptographic tracking engine 102 can be integrated with cryptographic tracking system 100 and/or processor 106.

Key management engine 104 can include a component for interfacing processor 106 with cryptographic keys. For example, key management engine 104 can allow processor 106 to retrieve and/or obtain cryptographic keys for encrypting and/or decrypting a data payload. In some embodiments, key management engine 104 can include a component for generating, managing, and/or maintaining cryptographic keys. In some embodiments, key management engine 104 can include a commercial off-the-shelf KMS application and/or service.

In some embodiments, key management engine 104 can include a software engine (e.g., an engine invoked by processor 106 based on program code executed by processor 106) such that functionalities of key management engine 104 can be accessed via an API. In some embodiments, key management engine 104 can include a combination of hardware and software (e.g., a processor configured to perform specific functions) such that key management engine 104 can perform functions and share data and/or commands with processor 106. Key management engine 104 can include various functions that can cause processor 106 to generate, retrieve, manage, and/or receive cryptographic keys. Key management engine 104 can receive requests for cryptographic keys from cryptographic tracking engine 102 and key management engine 104 can transmit requests and/or encrypted data to cryptographic tracking engine 102.

In some embodiments, processor 106 can receive input instructions (e.g., via input from a user) to share and/or transmit a data payload between application servicers (e.g., first application servicer 112, second application servicer 114, and/or application servicer 116). Upon processing the input instructions, processor 106 can invoke cryptographic tracking engine 102 to generate and populate tracking token 124 and/or retrieve or reference tracking token 124 stored in tracking token database 120 to determine whether the data payload can be shared and/or transmitted to an application servicer, based on a data context policy.

First application servicer 112, second application servicer 114, and application servicer 116 can include software engines and/or a combination of hardware and software as described herein. In some embodiments, first application servicer 112 and second application servicer 114 can include software engines defining one or more data services, such that first application servicer 112 and second application servicer 114 can receive data as input and can process the data to provide a service. In some embodiments, first application servicer 112 and second application servicer 114 cannot be directly accessible to a user of cryptographic tracking system 100 without the use of another application servicer (e.g., application servicer 116). For example, application servicer 116 can include a software engine for a user-facing application that can access one or more application servicers to provide various functions within a domain. As an example, application servicer 116 can include an application providing various functions of a business, while application servicer 116 can access various application servicers (e.g., first application servicer 112 and second application servicer 114) to perform functions that are not direct functions of the business, but are ancillary and can be used by various applications to perform tasks and are provided via application servicers. An example of an application servicer can include a software application for an online retailer, while an example of an application servicer can include a software service to process credit card payments. The application servicer is specific to the online retailer, while the application servicer can be a third-party service that is used by various online retailers to process credit card payments.

HSM server 118 can include a physical device configured to securely store, manage, and process cryptographic keys. For example, HSM server 118 can maintain and/or store cryptographic keys for key management system 104 such that sensitive cryptographic keys can be kept secure from unauthorized access.

Tracking token database 120 can include a database configured to store plural tracking tokens 122 for use by cryptographic tracking engine 102 and/or key management engine 104. In some embodiments, tracking token database 120 can include a registration authority (RA) configured to verify an identity of a user and/or an application servicer to authorizes the creation of a digital certificate such that the user and/or application servicer can use and/or receive a data payload that is encrypted or will be encrypted via key management engine 104.

In some embodiments, cryptographic tracking system 100 and/or cryptographic tracking engine 102 can be configured for managing access to encrypted data. Cryptographic tracking system 100 and/or cryptographic tracking engine 102 can include a key management server configured with program code for providing key management services, an encrypted database, and a processor coupled to the key management server. For example, cryptographic tracking system 100 can include key management server 104, encryption database 110, processor 106, and memory 108 as shown in FIG. 1.

In some embodiments, the processor can be configured with program code stored in memory for providing cryptographic tracking services (e.g., by executing program code for cryptographic tracking engine 102) and/or key management services. The program code for the key management services, when executed, can cause the key management server to encrypt a data payload to generate an encrypted data payload. The program code for the key management services can cause the key management server to store the encrypted data payload in the encrypted database. The program code for the cryptographic tracking services, when executed, can cause the processor to receive a request for encrypted data from a first application servicer. The program code for the cryptographic tracking services can cause the processor to determine that the first application servicer fulfills at least one conditional attribute defined by a data context policy referenced in the tracking token. The program code for the cryptographic tracking services can cause the processor to transmit a request to a decryption server (e.g., decryption server 122) requesting the decryption server to decrypt the encrypted data payload and transmit the data payload to the first application servicer. A decryption server can be configured to decrypt relevant data in encryption database 110. In some embodiments, the decryption server can be configured to perform decryption. Alternatively, the decryption server can transmit a public key to encryption database 110 to decrypt the encrypted data, which can then be transmitted to an application servicer. The decryption server can use a key encryption key (KEK) to decipher a data encryption key (DEK) in order to decrypt the encrypted data. In some embodiments, sensitive and/or encrypted data can be centralized (e.g., at a database or server) such that cryptographic tracking system 100 can bound any data audits for compliance purposes. In some embodiments, all application servicers may need to communicate with the decryption server in order to access and/or decrypt the encrypted data. This can ensure the security assurance of cryptographic tracking system 100 before cryptographic tracking system 100 can share sensitive data with external and/or other application servicers such that a promise of assurance can be stated with the at least one conditional attribute defined in the data context policy of the tracking token.

In some embodiments, cryptographic tracking system 100 and/or cryptographic tracking engine 102 can be configured for detecting compromised encrypted data. For example, cryptographic tracking system 100 and/or cryptographic tracking engine 102 can include memory 108 and processor 106 configured with program code stored in memory 108 for providing cryptographic tracking services (e.g., via cryptographic tracking engine 102). The program code can cause processor 106 to detect that first application servicer 114 has interacted with a data payload. For example, cryptographic tracking engine 102 can cause processor 106 to detect that first application servicer 114 has received and/or used an encrypted data payload to perform an operation (e.g., authorizing a payment).

In some embodiments, the program code can cause processor 106 to determine that first application servicer 112 has not been issued a tracking token or that a data context policy referenced in a tracking that has been issued to first application servicer 112 is not active. For example, cryptographic tracking engine 102 can issue tracking tokens to application servicers and cryptographic tracking engine 102 can then decide whether to activate or deactivate existing data context policies (e.g., within tracking token database) that are referenced in issued tracking tokens. The data context policy can correspond to the data payload in that the data context policy governs the use and/or context of the data payload and any security aspects thereof. In some embodiments, cryptographic tracking engine can activate and/or deactivate tracking based on conditions of services or conditions yet to be fulfilled (e.g. proofs that an application servicer has a CVE or does not have a CVE.

In some embodiments, the program code can cause processor 106 to terminate a connection of first application servicer 112 to prohibit access to additional data payloads. For example, cryptographic tracking engine 102 can cause processor 106 to terminate a connection of first application servicer 112 where first application servicer 112 does not possess an active tracking token (e.g., based on the state) or a tracking token with a data context policy that exists and/or is activated. In some embodiments, processor 106 can quarantine first application servicer 112 to prohibit access to additional data payloads.

In some embodiments, the data context policy referenced in the tracking token can require the first application servicer to communicate with the decryption server to access the encrypted data payload. For example, cryptographic tracking engine 102 can reference the intervention policy engine and tracking token database 120 to determine whether first application servicer 112 is required to contact the decryption server to access the encrypted data, and cryptographic tracking engine 102 can cause processor 106 to transmit a signal to first application servicer 112 to cause application servicer 112 to contact the decryption server to request the encrypted data. For example, the program code for cryptographic tracking engine 102 can cause processor 106 to transmit a signal to the decryption server to cause the decryption server to be prevented from decrypting the encrypted data payload in order to prohibit an application servicer from obtaining and/or accessing encrypted data (e.g., when the application servicer is determined to not be compliant with the data context policy and/or meet the conditional attributes).

In some embodiments, the processor can prevent the first application servicer from transmitting decrypted data to a second application servicer when the first application servicer and the second application servicer do not fulfill at least one conditional attribute defined by the data context policy referenced in the tracking token. For example, processor 106 can execute cryptographic tracking engine 102 to leverage the key control policy engine and tracking token database 120 to look up a tracking token to determine if first application servicer 112 and second application servicer 114 do not fulfill at least one conditional attribute defined by the data context policy referenced in the tracking token queried in tracking token database 120. In this instance, cryptographic tracking engine 102 can use the key control policy engine to reference contents of the tracking token to determine whether first application servicer 112 and second application service 114 satisfy the conditional attribute in the data context policy of the tracking token such that first application servicer 112 and second application servicer 114 can share encrypted data between each other. If cryptographic tracking engine 102 determines that first application servicer 112 and second application servicer 114 do not satisfy the conditional attribute (e.g., they contain vulnerabilities, etc.), then cryptographic tracking engine 102 can cause processor 106 to transmit a signal to first application servicer 112 to prevent first application servicer 112 from transmitting decrypted data to second application servicer 114. Additionally, cryptographic tracking engine 102 can cause processor 106 to transmit a signal to first application servicer 112 to delete the encrypted data form first application servicer 112, cause first application servicer 112 to be unable to use the encrypted data, and/or quarantine first application servicer 112 (e.g., in the event first application servicer 112 does not satisfy the conditional attribute), such that first application servicer 112 can no longer interact with the network and/or processor 106.

In some embodiments, the data context policy included in the tracking token (e.g., stored in tracking token database 120) can include plural conditional attributes for the first application servicer. For example, a tracking token can include a data context policy having plural conditional attributes pertaining to first application servicer 112 (e.g., requiring particular security compliance, lack of specific vulnerabilities, a purpose for using specific encrypted data, and/or the like). For example, the plural conditional attributes can relate to any one or more of a system attribute, a service attribute, an identity attribute (e.g., of a user identity), and a session attribute (e.g., of a user session).

In some embodiments, the tracking token can issue the data context policy to the first application servicer. The data context policy can permit or deny the first application servicer access to encrypted data based on a state of the tracking token. For example, the tracking tokens stored in tracking token database 120 can be issued to application services and can cause a data context policy to be issued to first application servicer 112 and/or second application servicer 114. The data context policy can permit or deny first application servicer 112 and/or second application servicer 114 to access encrypted data (e.g., in encryption database 110) based on a state of the tracking tokens. A state of the tracking tokens can include an initialized state, an operational-ready state, an operational-active state, a suspended state, and a terminated state. As an example, where first application servicer 112 is issued a data context policy for a tracking token that is in the terminated state, first application servicer 112 may automatically be denied access (e.g., by cryptographic tracking engine 102) to any encrypted data on the system and/or stored in encryption database 110 because the tracking token for first application servicer 112 is terminated, thus terminating any current data context policies assigned to first application servicer 112. In another example, first application servicer having a tracking token in the operation active state may not automatically permit or deny first application servicer 112 access to encrypted data, but the operational-active state may automatically require that, upon any requests for encrypted data from first application servicer 112, cryptographic tracking engine 102 must use the key control policy engine to check any conditional attributes defined in the data context policy of the operational-active tracking token against a current version of first application servicer 112 in order to determine compliance and therefore permission to access encrypted data.

In some embodiments, the program code for the cryptographic tracking services can cause the processor to prevent the decryption server from decrypting the encrypted data payload when the tracking token is in the suspended state. For example, cryptographic tracking engine 102 can transmit a signal to processor 106 to cause processor 106 to prevent the decryption server from decrypting the encrypted data payload when the tracking token is in the suspended state. In some embodiments, a tracking token in the suspended state can indicate that first application servicer 112 and/or second application servicer 114 has been detected by cryptographic tracking engine 102 to have a Common Vulnerability and Exposure (CVE).

In some embodiments, the program code for the cryptographic tracking services can cause the processor to perform data loss prevention (DLP) monitoring on the first application and the encrypted data payload. For example, processor 106 can execute cryptographic tracking engine 102 to perform DLP monitoring on first application servicer 112 after first application servicer has been permitted access to encrypted data and has received the encrypted data payload. Cryptographic tracking engine 102 can perform DLP monitoring on first application servicer 112 to ensure first application servicer 112 does not inadvertently expose the encrypted data payload, for example, via a later obtained vulnerability, attempting to share the encrypted data payload with other application services without permission, and so forth.

In some embodiments, the tracking token and a referenced data context policy (e.g., referenced in the tracking token) are canonized with a data schema used in the encrypted data payload, such that the data schema is part of the data context policy for certain types of data payloads and/or data formats.

The number and arrangement of systems, hardware, and/or software components shown in FIG. 1 is provided as an example. There can be additional systems, hardware, and/or software components, fewer systems, hardware, and/or software components, different systems, hardware, and/or software components, or differently arranged systems, hardware, and/or software components than those shown in FIG. 1. Furthermore, two or more systems, hardware, and/or software components shown in FIG. 1 can be implemented within a single system, hardware, and/or software component. A single system, hardware, and/or software component shown in FIG. 1 can be implemented as multiple, distributed systems, hardware, and/or software components. Additionally, or alternatively, a set of systems, a set of hardware, and/or a set of software components (e.g., one or more systems, one or more hardware devices, one or more software components) of FIG. 1 can perform one or more functions described as being performed by another set of systems, another set of hardware, or another set of software components of FIG. 1.

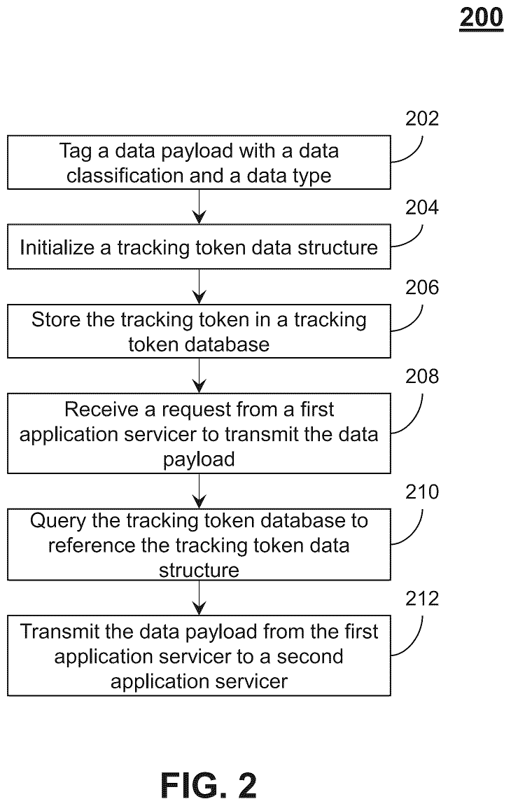

FIG. 2 shows a flow diagram of an exemplary method 200 for managing access to encrypted data as disclosed herein. In some embodiments, one or more of the functions described with respect to method 200 can be performed (e.g., completely, partially, etc.) by cryptographic tracking system 100 and/or cryptographic tracking engine 102 (e.g., via processor 106). In some embodiments, one or more of the steps of method 200 can be performed (e.g., completely, partially, etc.) by another system, hardware, or software component or a group of systems, hardware, or software components separate from or including cryptographic tracking system 100 and/or cryptographic tracking engine 102, such as a client device and/or a separate computing device.

As shown in FIG. 2, at step 202, method 200 can include tagging a data payload with a data classification and a data type. For example, cryptographic tracking engine 102 (e.g., executed by processor 106) can tag a data payload with a data classification and/or a data type. The data payload can include structured or unstructured data. In some embodiments, a data type can include a type of organization of data (e.g., file, file type, etc.) and/or whether the data is structured or unstructured. In some embodiments, a data classification can include a security classification of the data payload, e.g., whether the data is secret, sensitive, non-sensitive, public, etc. Examples of additional data types and/or classifications can be seen in FIG. 3.

At step 204, method 200 can include initializing a tracking token data structure. For example, cryptographic tracking engine 102 can initialize a tracking token data structure with tracking token 124 containing a data payload and a data context policy reference. The data context policy reference can indicate a data context policy which defines at least one conditional attribute for an application service (e.g., first application servicer 112, second application servicer 114, and/or application servicer 116) to interact with the data payload. In some embodiments, interacting with the data payload can include receiving the data payload and/or using the data payload as input for performing a function or service.

At step 206, method 200 can include storing the tracking token in a tracking token database. For example, cryptographic tracking engine 102 can store tracking token 124 in tracking token database 120 which can be accessible by key management engine 104. Tracking token 124 can be referenced by cryptographic tracking engine 102 and/or key management engine 104 to access the data context policy associated with the data context policy reference in tracking token 124. In this way, tracking token 124 ties a data context policy with a data payload, cryptographic keys, and engines requesting use of the data payload (e.g., the association between a data payload and a data context policy, along with various engines and/or application servicers and cryptographic keys, may be referred to herein as “entanglement” such that tracking token 124 allows data to be entangled to a context of protection of the data).

At step 208, method 200 can include receiving a request from a first application servicer to transmit the data payload. For example, cryptographic tracking engine 102 can receive a request from first application servicer 112. The request can specify that first application servicer 112 requests permission to transmit the data payload to second application servicer 114 to perform a function and/or service using the data payload. In some embodiments, the request can be generated by cryptographic tracking engine 102 based on first application servicer 112 attempting to transmit the data payload to second application servicer 114. In this way, cryptographic tracking engine 102 can monitor and track the data payload as the data payload is shared among various application servicers in cryptographic tracking system 100.

At step 210, method 200 can include querying the tracking token database to reference the tracking token data structure. For example, key management engine 104 (e.g., by execution by processor 106) can query tracking token database 120 to determine that second application servicer 114 satisfies the data context policy. Key management engine 104 can query tracking token database 120 to find tracking token 124 associated with second application servicer 114, and key management engine 104 can read the data context policy reference to determine the data context policy. Then, cryptographic tracking engine 102 can read the data context policy and the at least one conditional attributed associated therewith to determine whether second application servicer 114 can receive and/or use the data payload associated with tracking token 124. In this way, cryptographic tracking engine 102 can ensure the data payload is entangled with the data context policy.

At step 212, method 200 can include transmitting the data payload from the first application servicer to a second application servicer. For example, cryptographic tracking engine 102 can transmit the data payload from first application servicer 112 to second application servicer 114 when second application servicer 114 satisfies the data context policy. In some embodiments, second application servicer 114 can satisfy the data context policy when second application servicer 114 passes and/or fulfills the at least one condition attribute associated with the data context policy. For example, where the at least one conditional attribute requires absence of a CVE, second application servicer 114 can fulfill the at least one conditional attribute when second application servicer 114 does not possess the CVE.

In some embodiments, cryptographic tracking engine 102 can receive a request from the first application servicer to transmit the data payload to a second application. Cryptographic tracking engine 102 and/or key management engine 104 can query the tracking token database to determine that a second tracking token is present in the tracking token database including a second data context policy for the second application. Cryptographic tracking engine 102 can permit the first application servicer to transmit the data payload to the second application based on determining that the second application fulfills the second data context policy.

In some embodiments, cryptographic tracking engine 102 can receive a request from the first application servicer to transmit the data payload to a second application. Key management engine 104 can query the tracking token database to determine that a tracking token associated with the second application is not present in the tracking token database. Cryptographic tracking engine 102 can generate a second tracking token including a second data context policy which defines at least one conditional attribute for the second application to interact with the data payload.

In some embodiments, cryptographic tracking engine 102 can receive a request from the first application servicer to transmit the data payload to a second application. Key management engine 104 can query the tracking token database to determine that a second tracking token is present in the tracking token database including a second data context policy for the second application. Cryptographic tracking engine 102 can deny the request from the first application servicer to transmit the data payload to the second application based on determining that the second application does not fulfill the second data context policy.

In some embodiments, cryptographic tracking engine 102 can detect a common vulnerability present within the second application. Cryptographic tracking engine 102 can suspend the second tracking token associated with the second application based on detecting the common vulnerability.

In some embodiments, cryptographic tracking engine 102 can receive a notification indicating the common vulnerability is not present within the second application. Cryptographic tracking engine 102 can update the second tracking token in the tracking token database to remove a suspension of the second tracking token.

In some embodiments, cryptographic tracking engine 102 can detect the common vulnerability present within the second application based on executing a vulnerability scan of the second application.

In some embodiments, the at least one conditional attribute for an application servicer interacting with the data payload can be based on a tagged data type for the data payload.

In some embodiments, cryptographic tracking engine 102 can include an intervention policy engine and a key control policy engine to perform specific functions of cryptographic tracking engine 102.

In some embodiments, cryptographic tracking engine 102 can manage and/or track a lifecycle of a cryptographic key associated with the cryptographic key identifier stored in the tracking token.

Steps of method 200 can be performed in various orders and sequences and are not necessarily limited to being performed in the order shown in FIG. 2. Accordingly, steps of method 200 are not limited to any particular order and can be performed by various components, whether cryptographic tracking system 100 is implemented on a single computing device or multiple, distributed computing devices. Steps of method 200 can also be performed by a single processor of cryptographic tracking system 100 or by multiple processors of cryptographic tracking system 100.

FIG. 3 shows a diagram of example data types and/or data classifications that can be tagged and/or scanned for vulnerabilities as disclosed herein. In some embodiments, data types can include structured data types and/or unstructured data types. Examples of structured data types can include a file with a known schema, field-tagged data, and/or executable files. Such structured data can be scanned with a vulnerability scanner to detect one or more CVEs present within the data. Examples of unstructured data can include a file with an unknown schema, a binary blob, or a streamed data payload. Such unstructured data cannot always be typed, and in some instances can require specific data context policies for sharing and/or using data payloads with unstructured data.

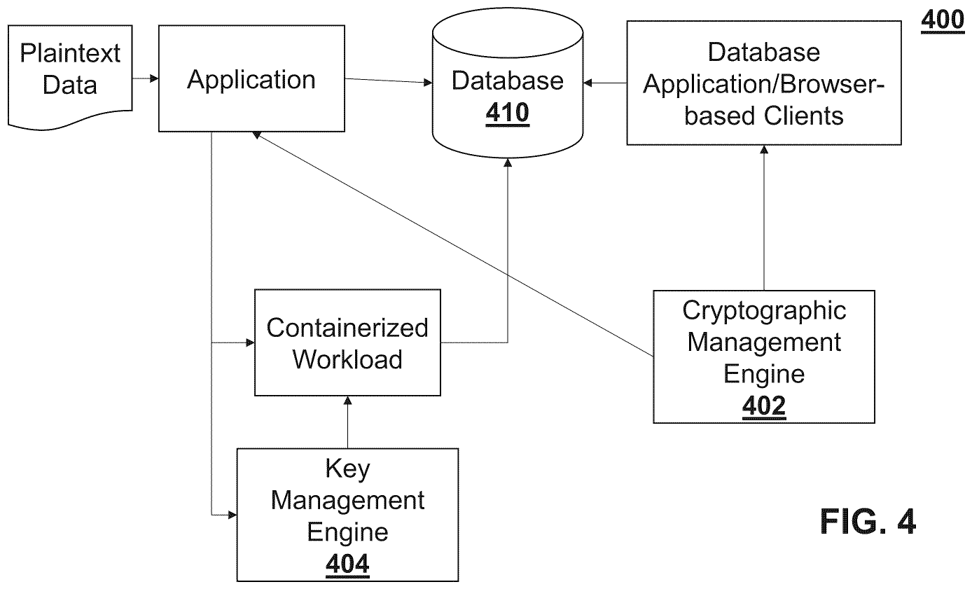

FIG. 4 shows a diagram of an exemplary architecture 400 for a computer system and/or network in which exemplary system configurations for managing access to encrypted data used by application services can be implemented as disclosed herein. As shown in FIG. 4, exemplary architecture 400 can include cryptographic management engine 402, key management engine 404, at least one application, database 410, a database application and/or browser-based clients, at least one containerized workload and plaintext data used as input to the at least one application. In some embodiments, the components shown in exemplary architecture 400 can be the same as or similar to the components shown and described with respect to FIG. 1.

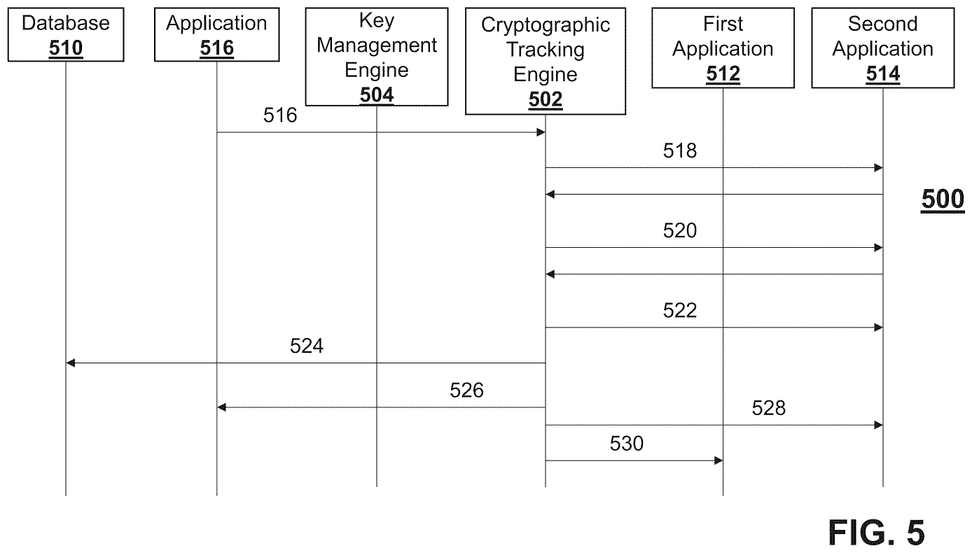

FIG. 5 shows a sequence diagram for a method 500 for an application servicer for obtaining a signed tracking token as disclosed herein. As shown in FIG. 5, method 500 can include steps 516-530. Step 516 can include request a tracking token to be signed. Step 518 can include performing a vulnerability scan on second application servicer 514 and receiving a response from second application servicer 514 that a CVE is present in second application servicer 514. Step 520 can include suspending the tracking token associated with second application servicer 514 and transmitting a message to second application servicer 514 that its tracking token has been suspended. Step 520 can also include receiving a response from second application servicer 514 indicating that the CVE has been remediated. Step 522 can include transmitting a message to second application servicer 514 indicating that the tracking token associated with second application servicer 514 is no longer suspended. Step 524 can include transmitting a signed copy of the tracking token to database 510, along with information indicating that the tracking token has been issued to first application servicer 512 and second application servicer 514. Step 526 can include transmitting a signed cacheable copy of the tracking token to application 516, along with information indicating that the tracking token has been issued to first application servicer 512 and second application servicer 514. Step 528 can include issuing a signed copy of the tracking to second application servicer 514 indicating that second application servicer 514 can receive and/or use the data payload associated with the tracking token. Step 530 can include issuing a signed copy of the tracking token to first application servicer 512 indicating that first application servicer 512 is permitted to transmit and/or share the data payload to second application servicer 514. Hardware components and/or software components shown in FIG. 5 can be the same as or similar to hardware components and/or software components shown and described with regard to FIG. 1.

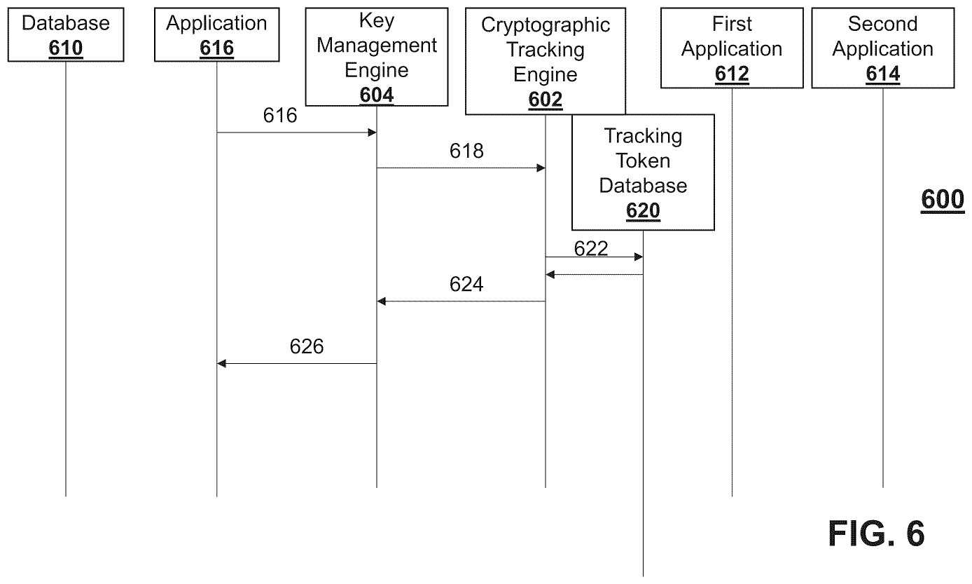

FIG. 6 is a sequence diagram for a method 600 for an application servicer for requesting encryption of a data payload as disclosed herein. As shown in FIG. 6, method 600 can include steps 616-626. Step 616 can include requesting, from key management engine 604, encryption or signing of a data payload. Step 618 can include forwarding the request for encryption or signing of the data payload from key management engine 604 to cryptographic tracking engine 602. Step 622 can include forwarding the request for encryption or signing of the data payload from cryptographic tracking engine 602 (e.g., a key control policy service thereof) to tracking token database 620. Step 622 can also include transmitting a response (e.g., that encrypting and/or signing of the data payload is permitted) from tracking token database 620 to cryptographic tracking engine 602. Step 624 can include storing a state of the data payload in cryptographic tracking engine 602 (e.g., a key control policy service thereof) and forwarding the response from cryptographic tracking engine 602 to key management engine 604 so key management engine 604 can perform encryption and/or signing of the data payload. Step 626 can include forwarding the encrypted and/or signed data payload from key management engine 604 to application 616. Hardware components and/or software components shown in FIG. 6 can be the same as or similar to hardware components and/or software components shown and described with regard to FIG. 1.

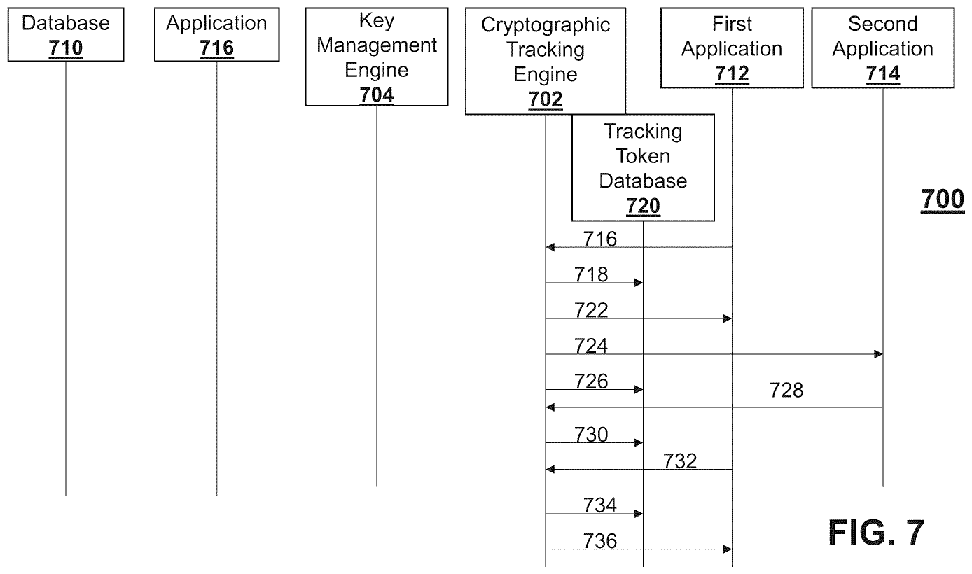

FIG. 7 is a sequence diagram for a method 700 for a first application servicer for interacting with and/or sharing a data payload with a second application servicer as disclosed herein. As shown in FIG. 7, method 700 can include steps 716-736. Step 716 can include requesting, by first application servicer 712 from cryptographic tracking engine 702, permission to transmit a data payload to and/or interacting with second application servicer 714. Step 718 can include cryptographic tracking engine 702 query tracking database 720 to confirm whether a data context policy for second application servicer 714 is present and/or is satisfied in tracking token database 720. Step 722 can include transmitting a response to first application servicer 712 denying first application servicer 712 permission to interact with second application servicer 714 because second application servicer 714 has a CVE. Step 724 can include transmitting a message to second application servicer 714 informing second application servicer 714 that the tracking token associated with second application servicer 714 is suspended. Step 726 can include updating the tracking token in tracking token database 720 associated with second application servicer 714. Step 728 can include receiving a message from second application servicer 714 that the CVE with second application servicer 714 has been remediated. Step 730 can include updating the tracking token in the tracking token database 720 associated with second application servicer 714 to indicate that the CVE with second application servicer 714 has been remediated. Step 732 can include first application servicer 712 transmitting a request to cryptographic tracking engine 702 requesting to interact with second application servicer 714. Step 734 can include querying the tracking token database 720 to confirm whether a data context policy is present and/or is satisfied by second application servicer 714. Step 736 can include transmitting a response to first application servicer 712 confirming that second application servicer 714 satisfies the data context policy in the tracking token associated with second application servicer 714 and permitting first application servicer 712 to interact with second application servicer 714, including sharing the data payload. Hardware components and/or software components shown in FIG. 7 can be the same as or similar to hardware components and/or software components shown and described with regard to FIG. 1.

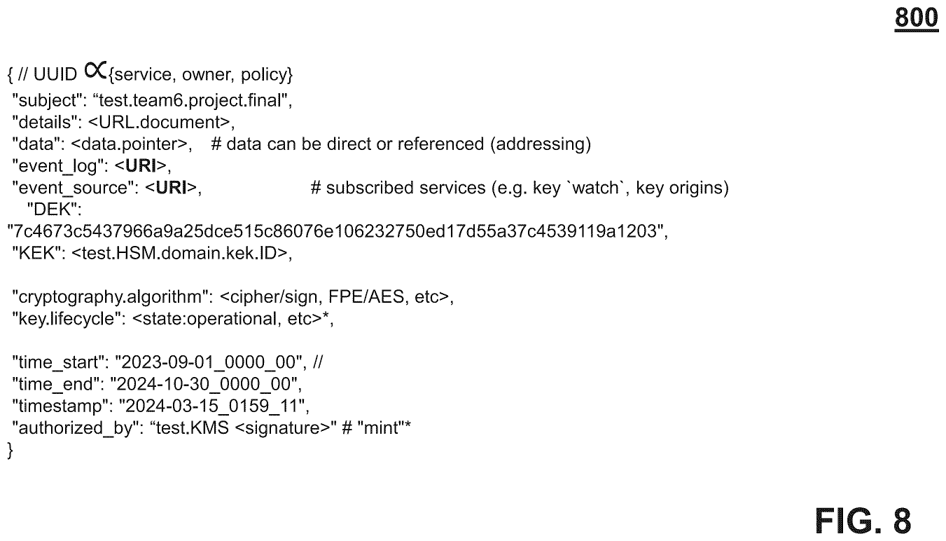

FIG. 8 is an exemplary data structure 800 for a tracking token including a data payload and a cryptographic key identifier as disclosed herein. As shown in FIG. 8, data structure 800 can include a unique identifier associated with at least a service, an owner, and/or a policy. Data structure 800 can include a data payload (or a pointer to a stored data payload), an event source, and a DEK and KEK associated with the data payload. As shown in FIG. 8, other information and/or fields can be included in data structure 800, including a reference to a data context policy and a validity condition including at least one of a start time, an end time, and a lifecycle state for the cryptographic key identifier. Exemplary data structure 800, as used herein in a tracking token (e.g., tracking token 124) can ensure a data payload remains entangled to a context of protection of the data payload (e.g., a data context policy) such that the data payload is kept secure from unauthorized use by other services or applications in a computing system.

As disclosed herein, tracking token 124 can be generated based on exemplary data structure 800. Tracking token 124 can include a unique identifier associated with an application service, an owner (e.g., a user and/or a system), and/or a data context policy. Tracking token 124 may store detailed information such as a URL document. Tracking token 124 can also store a data payload or a reference to the data payload (e.g., a pointer to a memory location where the data payload is stored). In this way, cryptographic tracking engine 102 can provide a data structure in the form of tracking token 124 to associate the data payload with cryptographic keys and a data context policy, which allows for the sharing and/or use of the data payload to tracked and managed securely, such that the data payload is not shared with applications and/or services that are unsecure. In some embodiments, tracking token 124 may store other data associated with the data payload and/or the cryptographic keys, as shown in FIG. 8.

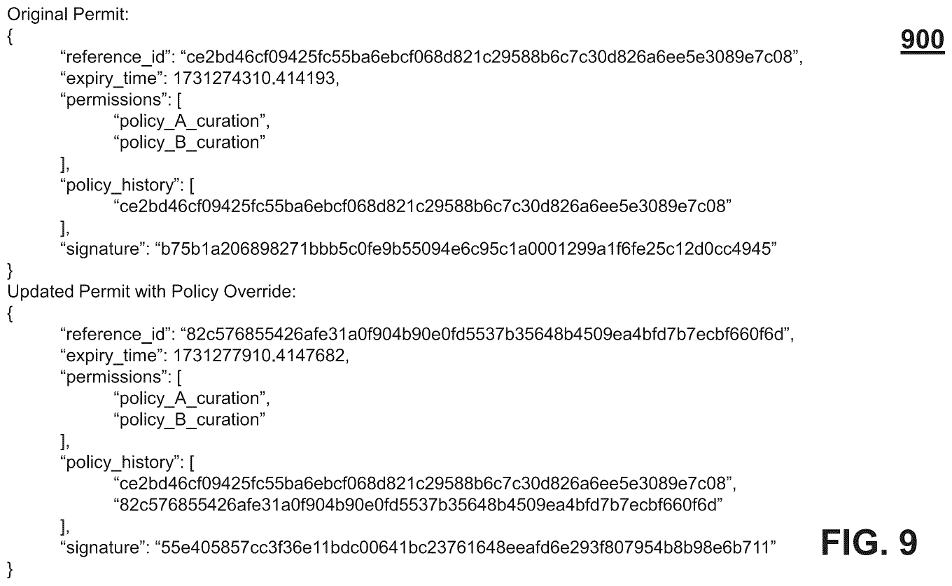

FIG. 9 is another exemplary data structure 900 for a tracking token including a data payload and a cryptographic key identifier as disclosed herein. As shown in FIG. 9, data structure 900 can include a reference identifier to reference a data context policy and data structure 900 can include a signature based on a key management engine (e.g., key management engine 104) signing a tracking token. In some embodiments, the reference identifier can include a hashed value. Tracking token 124 having data structure 900 may include names of data context policies as well as history of the data context policies, also stored in tracking token 124 in the form of a hashed value. Tracking token 124 may also be signed with a signature (e.g., from key management engine 104) to verify authenticity of tracking token 124. Exemplary data structure 900, as used herein in a tracking token (e.g., tracking token 124) can ensure a data payload remains entangled to a context of protection of the data payload (e.g., a data context policy) such that the data payload is kept secure from unauthorized use by other services or applications in a computing system.

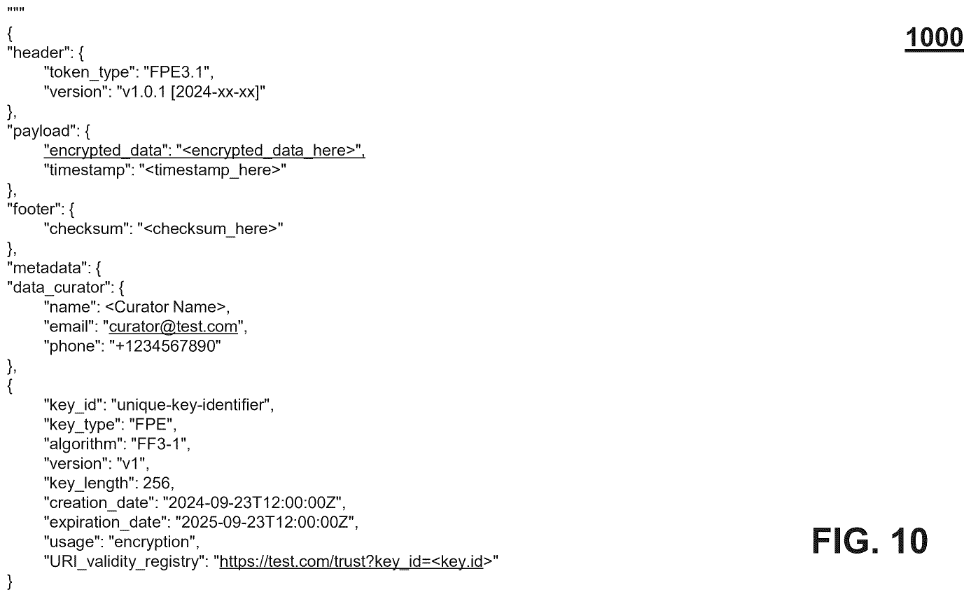

FIG. 10 is another exemplary data structure 1000 for a tracking token including a data payload and a cryptographic key identifier as disclosed herein. As shown in FIG. 10, data structure 1000 can include a data payload or a reference to a data payload (e.g., an encrypted data payload), a unique cryptographic key identifier, and other information used to track and/or manage a lifecycle of a cryptographic key. As shown in FIG. 10, data structure 1000 associates a cryptographic key identifier with a data payload. In some embodiments, tracking token 102 can include data structure 1000 to store a creation date and/or an expiration date of a cryptographic key, further allowing cryptographic tracking engine 102 to manage a lifecycle of the cryptographic key and associate the cryptographic key and its lifecycle with the data payload involved. Exemplary data structure 1000, as used herein in a tracking token (e.g., tracking token 124) can ensure a data payload remains entangled to a context of protection of the data payload (e.g., a data context policy) such that the data payload is kept secure from unauthorized use by other services or applications in a computing system.

Any of the processors disclosed herein can include any integrated circuit or other electronic device (or collection of devices) capable of performing an operation on at least one instruction, which can include a Reduced Instruction Set Core (RISC) processor, a CISC microprocessor, a Microcontroller Unit (MCU), a CISC-based CPU, a DSP, a GPU, a Field Programmable Gate Array (FPGA), etc. The hardware of such devices can be integrated onto a single substrate (e.g., silicon “die”), or distributed among two or more substrates. Various functional aspects of the processor can be implemented solely as software or firmware associated with the processor.

The processor can include one or more processing or operating modules. A processing or operating module can be a software or firmware operating module configured to implement any of the functions disclosed herein. The processing or operating module can be embodied as software and stored in memory; the memory being operatively associated with the processor. A processing module can be embodied as a web application, a desktop application, a console application, etc.

The processor can include or be associated with a computer or machine readable medium. The computer or machine readable medium can include memory. Any of the memory discussed herein can be computer readable memory configured to store data. The memory can include a volatile or non-volatile, transitory or non-transitory memory, and be embodied as an in-memory, an active memory, a cloud memory, etc. Examples of memory can include flash memory, RAM, ROM, Programmable Read only Memory (PROM), Erasable Programmable Read only Memory (EPROM), Electronically Erasable Programmable Read only Memory (EEPROM), FLASH-EPROM, Compact Disc (CD)-ROM, Digital Optical Disc DVD), optical storage, optical medium, a carrier wave, magnetic cassettes, magnetic tape, magnetic disk storage or other magnetic storage devices, or any other medium which can be used to store the desired information and which can accessed by the processor.

The memory can be a non-transitory computer-readable medium. The term “computer-readable medium” (or “machine-readable medium”) as used herein is an extensible term that refers to any medium or any memory, that participates in providing instructions to the processor for execution, or any mechanism for storing or transmitting information in a form readable by a machine (e.g., a computer). Such a medium can store computer-executable instructions to be executed by a processing element and/or control logic, and data which is manipulated by a processing element and/or control logic, and can take many forms, including but not limited to, non-volatile medium, volatile medium, transmission media, etc. The computer or machine readable medium can be configured to store one or more instructions thereon. The instructions can be in the form of algorithms, program logic, etc. that cause the processor to execute any of the functions disclosed herein.

Embodiments of the memory can include a processor module and other circuitry to allow for the transfer of data to and from the memory, which can include to and from other components of a communication system. This transfer can be via hardwire or wireless transmission. The communication system can include transceivers, which can be used in combination with switches, receivers, transmitters, routers, gateways, wave-guides, etc. to facilitate communications via a communication approach or protocol for controlled and coordinated signal transmission and processing to any other component or combination of components of the communication system. The transmission can be via a communication link. The communication link can be electronic-based, optical-based, opto-electronic-based, quantum-based, etc. Communications can be via Bluetooth, near field communications, cellular communications, telemetry communications, Internet communications, etc.

Data stored in the exemplary computing device (e.g., in the memory) can be stored on any type of suitable computer readable media, such as optical storage (e.g., a compact disc, digital versatile disc, Blu-ray disc, etc.), magnetic tape storage (e.g., a hard disk drive), or solid-state drive. An operating system can also be stored in the memory.

In an exemplary embodiment, the data can be configured in any type of suitable database configuration, such as a relational database, a structured query language (SQL) database, a distributed database, an object database, etc. Suitable configurations and storage types will be apparent to persons having skill in the relevant art.

The exemplary computing device can also include a communications interface. The communications interface can be configured to allow software and data to be transferred between the computing device and external devices. Exemplary communications interfaces can include a modem, a network interface (e.g., an Ethernet card), a communications port, a PCMCIA slot and card, etc. Software and data transferred via the communications interface can be in the form of signals, which can be electronic, electromagnetic, optical, or other signals as will be apparent to persons having skill in the relevant art. The signals can travel via a communications path, which can be configured to carry the signals and can be implemented using wire, cable, fiber optics, a phone line, a cellular phone link, a radio frequency link, etc. Transmission of data and signals can be via transmission media. Transmission media can include coaxial cables, copper wire, fiber optics, etc. Transmission media can also take the form of acoustic or light waves, such as those generated during radio-wave and infrared data communications, or other form of propagated signals (e.g., carrier waves, digital signals, etc.).

Memory semiconductors (e.g., DRAMs, etc.) can be means for providing software to the computing device. Computer programs (e.g., computer control logic) can be stored in the memory. Computer programs can also be received via the communications interface. Such computer programs, when executed, can enable computing device to implement the present methods as discussed herein. In particular, the computer programs stored on a non-transitory computer-readable medium, when executed, can enable hardware processor device to implement the methods as discussed herein. Accordingly, such computer programs can represent controllers of the computing device.

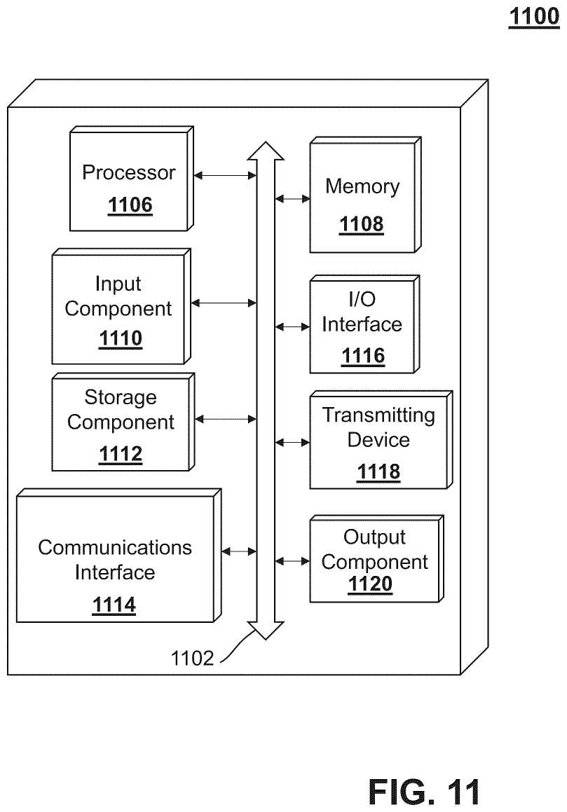

FIG. 11 shows a diagram of example components of a computing device or system 1100 as disclosed herein. Computing device 1100 (and/or at least one component of computing device 1100) can correspond to at least one of cryptographic tracking system 100, processor 106, memory 108, and/or database 110 in FIG. 1. In some embodiments, such systems or devices in FIG. 1 can include at least one computing device 1100 and/or at least one component of computing device 1100. The number and arrangement of components shown in FIG. 11 are provided as an example. In some embodiments, computing device 1100 can include additional components, fewer components, different components, or differently arranged components than those shown in FIG. 11. Additionally, or alternatively, a set of components (e.g., one or more components) of computing device 1100 can perform one or more functions described as being performed by another set of components of computing device 1100.

Computing system or device 1100 can include processor 1106, memory 1108, receiving device 1114, network interface 1116, input/output (I/O) interface 1118, transmitting device 1120, communications interface 1122, communication infrastructure 1124, and input device 1126. Memory 1108 can be the same as or similar to memory 108 as disclosed herein. Processor 1106 can be the same as or similar to processor 106 as disclosed herein.

Memory 1108 can be configured for storing program code for at least one machine learning model. Memory 1108 can include one or more memory devices such as volatile or non-volatile memory. For example, the volatile memory can include random access memory. According to exemplary embodiments, the non-volatile memory can include one or more resident hardware components such as a hard disk drive and a removable storage drive (e.g., a floppy disk drive, a magnetic tape drive, an optical disk drive, a flash memory, or any other suitable device). The non-volatile memory can include an external memory device connected to communicate with the system 1100 via a mobile communication network. According to an exemplary embodiment, an external memory device can be used in place of any resident memory devices. Data stored in system 1100 can be stored on any type of suitable computer readable media, such as optical storage (e.g., a compact disc, digital versatile disc, Blu-ray disc, etc.) or magnetic tape storage (e.g., a hard disk drive). The stored data can include network traffic data, log data, streaming events, and/or CDRs generated and/or accessed by processor 1106, and software or program code used by processor 1106 for performing the tasks associated with the exemplary embodiments described herein. The data can be configured in any type of suitable database configuration, such as a relational database, a structured query language (SQL) database, a distributed database, an object database, etc. Suitable configurations and storage types will be apparent to persons having skill in the relevant art.

Receiving device 1114 can be a combination of hardware and software components configured to receive data samples from the mobile network or database. According to exemplary embodiments, receiving device 1114 can include a hardware component such as an antenna, a network interface (e.g., an Ethernet card), a communications port, a Personal Computer Memory Card International Association (PCMCIA) slot and card, 5G New Radio (NR) interface, or any other component or device suitable for use on a mobile communication network or Radio Access Network as desired. Receiving device 1114 can be an input device for receiving signals and/or data samples formatted according to 3GPP protocols and/or standards. Receiving device 1114 can be connected to other devices via a wired or wireless network or via a wired or wireless direct link or peer-to-peer connection without an intermediate device or access point. The hardware and software components of receiving device 1114 can be configured to receive the data from the mobile network according to one or more communication protocols and data formats. For example, receiving device 1114 can be configured to communicate over a network, which can include a LAN, a WAN, a wireless network (e.g., Wi-Fi), a mobile communication network, a satellite network, the Internet, fiber optic cable, coaxial cable, infrared, radio frequency (RF), another suitable communication medium as desired, or any combination thereof. During a receive operation, receiving device 1114 can be configured to identify parts of the received data via a header and parse the data signal and/or data packet into small frames (e.g., bytes, words) or segments for further processing at processor 1106.

Processor 1106 can be configured for executing the program code stored in memory 1108. Processor 1106 can be a special purpose or a general purpose computing device encoded with program code or software for performing the exemplary functions and/or features disclosed herein. According to exemplary embodiments of the present disclosure, processor 1106 can include a CPU. The CPU can be connected to the communications infrastructure including a bus, message queue, or network, multi-core message-passing scheme, for communicating with other components of computing system 1100, such as memory 1108, input device 1126, communications interface 1122, and I/O interface 1118. The CPU can include one or more processors such as a microprocessor, microcomputer, programmable logic unit or any other suitable hardware computing devices as desired.

I/O interface 1118 can be configured to receive the signal from processor 1106 and generate an output suitable for a peripheral device via a direct wired or wireless link. I/O interface 1118 can include a combination of hardware and software for example, a processor, circuit card, or any other suitable hardware device encoded with program code, software, and/or firmware for communicating with a peripheral device such as a display device, printer, audio output device, or other suitable electronic device or output type as desired.

Transmitting device 1120 can be configured to receive data from processor 1106 and assemble the data into a data signal and/or data packets according to the specified communication protocol and data format of a peripheral device or remote device to which the data is to be sent. Transmitting device 1120 can include any one or more of hardware and software components for generating and communicating the data signal over communications infrastructure 1124 and/or via a direct wired or wireless link to a peripheral or remote device. Transmitting device 1120 can be configured to transmit information according to one or more communication protocols and data formats as discussed in connection with receiving device 1114.

According to exemplary embodiments described herein, memory 1108 and processor 1106 can store and/or execute computer program code for performing the specialized functions described herein. It should be understood that the program code can be stored on a non-transitory computer usable medium, such as memory devices for the system 1100 (e.g., computing device), which can be memory semiconductors (e.g., DRAMs, etc.) or other tangible non-transitory means for providing software to system 1100. The computer programs (e.g., computer control logic) or software can be stored in memory devices (e.g., device memory 1108) resident on/in system 1100. The computer programs can also be received from external storage devices and/or network storage locations via a communications interface. Such computer programs, when executed, can enable system 1100 to implement the present methods and exemplary embodiments discussed herein. Accordingly, such computer programs can represent controllers of system 1100. Where the present disclosure is implemented using software, the software can be stored in a computer program product or non-transitory computer readable medium and loaded into system 1100 using any one or combination of a removable storage drive, an interface for internal or external communication, and a hard disk drive, where applicable.

In the context of exemplary embodiments of the present disclosure, a processor can include one or more modules or engines configured to perform the functions of the exemplary embodiments described herein. Each of the modules or engines can be implemented using hardware and, in some instances, can also utilize software, such as corresponding to program code and/or programs stored in memory. In such instances, program code can be interpreted or compiled by the respective processors (e.g., by a compiling module or engine) prior to execution. For example, the program code can be source code written in a programming language that is translated into a lower level language, such as assembly language or machine code, for execution by the one or more processors and/or any additional hardware components. The process of compiling can include the use of lexical analysis, preprocessing, parsing, semantic analysis, syntax-directed translation, code generation, code optimization, and any other techniques that can be suitable for translation of program code into a lower level language suitable for controlling system 1100 to perform the functions disclosed herein. It will be apparent to persons having skill in the relevant art that such processes result in system 1100 being a specially configured computing device uniquely programmed to perform the functions of the exemplary embodiments described herein.

### Technical Advantages

A technical advantage provided by the disclosed system is that it prevents cryptographic amnesia by persistently binding the protected data to a specific cryptographic key and a usage context under which the data is permitted to be processed. The described cryptographic tracking engine generates a tracking token for a data payload that has a data structure that associates the data payload with a cryptographic key identifier and with a data context policy reference, and stores the tracking token in a tracking token database. By embedding these associations into a machine-readable token and retaining the token in a tracking token database, the system maintains a verifiable and retrievable linkage between the data, the cryptographic key, and the governing policy, rather than relying on scattered configuration files or static credentials that can become stale, lost, orphaned or disconnected over time.

A further technical advantage is that the system allows cryptographic operations only after verifying, at runtime, that the service environment satisfies defined security conditions. This advantage arises because the cryptographic tracking engine scans the first application servicer to identify security attributes of the first application servicer, queries the tracking token database to obtain the data context policy for the data payload, and compares the security attributes to the conditional attributes defined by the data context policy before transmitting a permit signal to the key management engine. Because encryption is permitted only when the runtime security attributes satisfy the stored conditional attributes, the system enforces context-aware cryptographic use and enables an automatic response when a service environment does not satisfy the defined security conditions.

Embodiments disclosed herein provide various improvements to current data encryption technology and security tracking, including aligning a context of an encryption key and encrypted data to the key used to encrypt that data (e.g., via data-key “entanglement,” such that contextual information is embedded with the key and the encrypted data). For example, aligning a context of an encryption key and a context of encrypted data to the encryption key used to encrypt the data (e.g., the data-key “entanglement”) can directly improve security of sensitive data that is shared among applications. Such context alignment can be accomplished by generating a tracking token for a data payload having a data structure that associates the data payload with a cryptographic key identifier (e.g., for a cryptographic key used to encrypt the data payload) and with a data context policy reference to a data context policy for use of a cryptographic key identified by the cryptographic key identifier. The data context policy can provide internal system logic, data tags, and/or rules for the data payload, the cryptographic key that is used to encrypt the data payload, and/or applications requesting to use the data payload and/or cryptographic key in order to provide an additional layer of security for the data payload (e.g., depending on the type of data, how the data is used, what applications are requesting the data, how secure the requesting applications may be, etc.). For example, the data context policy defines at least one conditional attribute for an application servicer interacting with the data payload requiring the application servicer to meet certain security requirements, have a reason for requesting the data payload (e.g., the application is the type of application expected to request the type of data payload—like a payment application requesting credit card payment data). The use of the tracking token allows for tracking the data payload and cryptographic key and connecting them to the data context policy, while the data context policy can allow security systems to effectively track various attributes related to the cryptographic key and the encrypted data, including external systems and/or applications involved in using/requesting the data payload, vulnerability status of the external systems, reasons for the external systems to request certain encrypted data, a type of encryption algorithm used to encrypt the data, and so forth.

The described encryption key and/or data tracking of disclosed embodiments can also provide the security system with awareness of which external systems may be independently vulnerable such that the security system can detect vulnerabilities in the external systems using and/or requesting encrypted data such that the security system can perform effective, timely, and proactive interventions to revoke access to encrypted data, deny requests for encrypted data, and/or quarantine external services and/or systems that requested the encrypted data or used the encrypted data. The security system could scan the first application servicer to identify security attributes of the first application servicer. The security system may access a database to determine various security attributes of requesting applications such that the security system can directly leverage this security information against the data context policy to determine whether to allow the external system (e.g., the first application servicer) to use the data payload and/or encryption key. The security system can easily access any tracking token and/or data context policy by storing the tracking token in a tracking token database and using the tracking tokens to find and use references to stored data context policies. Thus, embodiments disclosed herein address several technical problems related to encryption key and/or data management, cryptographic assurance, and system interoperability. Embodiments can provide the following specific technical advantages.

Embodiments provide enhanced inventory management and intervention capabilities by preventing cryptographic systems from becoming amnesic and instead maintain continuous awareness of how, when, and under what conditions cryptographic keys protect data as the data is classified and propagated across application servicers (e.g., “first application servicer” and “second application servicer”). This technical advantage is achieved by tagging a data payload with a data classification and a data type, generating a tracking token for each data payload in which the token data structure associates the payload with a cryptographic key identifier and a data context policy reference, and further associating the payload with a validity condition including a start time, end time, or lifecycle state for the cryptographic key identifier, and storing the tracking token in a tracking token database, thereby preserving stored policy and key context for the data payload across encryption, storage, access events and servicer to servicer transmission events and enabling ongoing monitoring and enforcement rather than one-time authorization at key issuance. In some embodiments, this stored policy and key context for the data payload is further supported by tagging the data payload with a data classification and a data type and by initializing the tracking token data structure with the data payload and the data context policy reference.

Embodiments can also provide fine-grained control on sharing of encrypted data, for example, for selective machine learning analytics. The fine-grained controls can be implemented by requiring the security system to query a tracking token database storing tracking tokens referencing data context policies each time that the security system detects and/or receives a request for encrypted data or a request to encrypt data. The security system can then compare at least one conditional attribute in the data context policy to security attributes of a requesting application, such that the security system can control which applications can receive and/or use the encryption keys and/or data. This provides a technical advantage of continuous monitoring of sensitive data and encryption keys that are passed between applications (e.g., potentially vulnerable applications) for use.

Embodiments further provide structured key and token management, including longevity and usage tracking that addresses limitations of existing certificate-based approaches. This advantage is provided by implementing lifecycle aware validity conditions for cryptographic key identifiers, cryptographic tracking services to query the tracking token database when servicing access requests, and key management services to encrypt and store data payloads in an encrypted database while deferring access decisions to policy evaluation at request time. In combination, these features separate key management, encrypted data storage, and access control, so that encryption and decryption are performed only when current key lifecycle state and/or applicable policy requirements are satisfied, rather than relying on static trust assumptions. In some embodiments, this key structure and token management is further reflected by requiring that the tracking token be stored in a tracking token database accessible by the key management engine and that, upon receiving a request from a first application servicer to transmit the data payload to a second application servicer, the key management engine queries the tracking token database to determine whether the second application servicer satisfies the data context policy before allowing transmission.

Moreover, embodiments can track a path of encrypted data through various applications and/or external systems via a tracking token and data tagging to follow a path of a data payload as it is used by various applications. Each application's and/or external system's use of the cryptographic data can be monitored by assessing the system against the tracking token for the encrypted data. The security system can accomplish this by scanning applications and/or external systems to identify security attributes of the applications and/or external systems and comparing the security attributes against a data context policy for the tracking tokens. The security system can transmit a signal to a key management engine to permit the key management engine to encrypt data and/or manage encrypted data for a requesting application and/or external system when the application and/or external system fulfills at least one conditional attribute defined by a data context policy included in the tracking token, allowing the application and/or external system to receive and use the encrypted data. Thus, embodiments can provide advantages of tracking usage of encrypted data and examining additional conditions of applications to ensure use of the encrypted data remains secure throughout the lifecycle of the data.

Embodiments further provide tokenization with traceability, enabling tracking and tracing of data, cryptographic keys, and the systems involved in contextual use and lifecycles. This technical advantage is provided by generating a tracking token for each data payload which associates each data payload with a cryptographic key identifier and a data context policy defining conditional attributes for an application servicer interacting with the data payload, together with evaluating whether a requesting application servicer fulfills those conditional attributes prior to authorizing access to encrypted data. In some embodiments, traceability is extended to post-encryption access by requiring that decryption requests be issued only after cryptographic tracking services determine policy compliance, thereby establishing a cryptographic lineage that links encrypted data at rest, governing policy, and the identity and security posture of the requesting application servicer. In some embodiments, traceability is captured in the servicer to servicer propagation context by conditioning transmission of the data payload from the first application servicer to the second application servicer on a determination that the second application servicer satisfies the data context policy based on querying the tracking token database.

Embodiments further provide automated and trusted responses to cryptographic vulnerabilities. This advantage is achieved by detecting that an application servicer has interacted with a data payload, determining that the application servicer is not issued a tracking token or does not satisfy a corresponding data context policy, and preventing further access by terminating the application servicer's connection. These features support containment of non-compliant or potentially compromised entities across encryption and decryption paths by enforcing policy and token-based access at the time of interaction. In some embodiments, containment is provided by requiring that transmission between application servicers is permitted only when the recipient application servicer satisfies the applicable data context policy.

Moreover, embodiments can trace stakeholders (e.g., applications and/or external systems) and automatically respond to detected and/or known vulnerabilities in cryptographic algorithms, tools, or application servicers requesting encrypted data, such as Heartbleed in OpenSSL. For example, embodiments can accomplish this by scanning applications and/or external systems to identify security attributes, vulnerabilities, or other security issues of the applications and/or external systems.

Embodiments further provide an assured entropy source by tracking a source of cryptographic key generation (e.g., via encryption requests) and ensuring proper entropy, embodiments can provide a higher level of trust and security when using and/or sharing encrypted data. For example, the security system can accomplish this by receiving requests from a key management engine where the request asks to encrypt a data payload and the request is sent based on a first request from an application and/or external system trying to gain access to encrypted data (e.g., an encrypted version of the data payload). Thus, the security system can track a source of a request for newly encrypted data and can track where the encrypted data is transmitted and/or shared to ensure proper entropy of encrypted data and cryptographic keys.

Embodiments further provide improved audit and compliance capabilities by implementing audit trails. Embodiments can provide comprehensive audit trails for encryption keys and/or encrypted data that detail a source of key generation (e.g., via the original request to encrypt the data) and conditions for use of keys and encrypted data, thus enhancing compliance and security posture of systems and/or networks. For example, the security system can accomplish this by querying a tracking token database to find a tracking token for a particular data payload and/or cryptographic key and can compare at least one conditional attribute in a data context policy of the tracking token to the security attributes of the first application servicer to determine that a requesting application and/or external system fulfills the at least one conditional attribute. The security system may track each result of fulfillment of the conditional attributes in the data context policy for specific applications and/or external systems and can record this data within the tracking token stored in the tracking token database. Thus, embodiments can provide comprehensive audit trails for encryption keys and/or encrypted data embedded in tracking tokens stored in a tracking token database.

Embodiments further provide interoperability and flexibility (customizability) by avoiding proprietary constraints. Embodiments can avoid and/or be agnostic to proprietary payload structures (e.g., bit flags, byte structs, salt headers) to ensure greater flexibility and interoperability with other cryptographic solutions. This can allow other system logic to be extensible and adaptive to means of token interoperability and can enable a strong technological strategic advantage for various services (e.g., payments). Embodiments can be configured to generate mass notifications (and/or updates) to provide interoperability. Currently, some processes are still relayed due to non-fine-grained data access or redaction and incompatibility of token structure. Embodiments can overcome these existing structures with a unified token structure as disclosed herein. For example, the security system can accomplish this advantage by generating a tracking token for data having a data structure that associates the data with a cryptographic key identifier for a cryptographic key and with a data context policy reference to a data context policy. Thus, the security system can use a token structure that can be interoperable with various cryptographic solutions, providing flexibility with existing systems and reducing or eliminating system rework.

As an example in the payments space, pre-compiled server pages (PSP) can process issued tokens by different acquirers that may need to process subsequent transactions under different policies and schema (e.g., mapping the token against a card's PAN or conditions of usage, etc.). To change acquirers (or shift processing share), merchants are not required to de-tokenize cards stored on file and convert them to another provider. Neither would merchants need to re-tokenize a consumer's card by collecting the consumer's information again (potentially risking customer retention/conversion) as embodiments are composable and can be protected by ciphers and authenticated with public key infrastructure (PKI) credentials. The format used in disclosed embodiments can remove friction and offer an agnostic solution with cryptographic technical lift to move or share among processors.

Embodiments can be customized and extended to meet specific business and/or organizational use cases by specifically customizing generated tracking tokens and the associated data context policies such that cryptographic permit logic engines can be programmed or configured to apply custom logic and/or rules for specific data context policies referenced by tracking tokens, making embodiments adaptable to various organizational needs.

Embodiments further provide cryptographic assurance and contextual usage tracing by implementing a data-key “entanglement”. Embodiments can ensure a direct relationship (e.g., “entanglement”) between encrypted data and cryptographic keys used to encrypt and protect the data, providing cryptographic assurance and context that can be used to trace the contextual usage of both the encrypted data and the keys used to encrypt the data. The security system can accomplish this by generating tracking tokens for data, the tracking tokens having a data structure that associates the data with a cryptographic key identifier (e.g., for a cryptographic key) and with a data context policy reference to a data context policy. Thus, embodiments can accomplish “entanglement” by incorporating the tracking tokens associating data and cryptographic keys with a data context policy which can be used to track and/or compare attributes of applications using and/or requesting the data and cryptographic keys, thus providing advantageous contextual use tracing and improving overall security for encrypted data and associated encryption keys.

Embodiments further provide comprehensive security assurance via the “entanglement” process which helps to maintain a secure posture of networked systems by ensuring that every cryptographic key and data usage is tracked (e.g., through tracking tokens) and can be verified independently using referenced data context policies and conditional attributes (e.g., logic) embedded therein. Thus, embodiments provide a structured means to enroll data via tracking tokens (with the traceability with key lifecycle).

It will be appreciated by those skilled in the art that the present invention can be embodied in other specific forms without departing from the spirit or essential characteristics thereof. The presently disclosed embodiments are therefore considered in all respects to be illustrative and not restrictive. The scope of the invention is indicated by the appended claims rather than the foregoing description and all changes that come within the meaning and range and equivalence thereof are intended to be embraced therein.

What is claimed is:

1. A system for managing access to encrypted data used by application servicers, the system comprising:
a processor configured with program code stored in memory for one or more cryptographic permit logic engines providing services including a key management engine and a cryptographic tracking engine, wherein the program code for the cryptographic tracking engine, when executed, will cause the processor to:
generate a tracking token for a data payload having a data structure that associates the data payload with a cryptographic key identifier and with a data context policy reference to a data context policy, wherein the data context policy defines at least one conditional attribute for an application servicer interacting with the data payload, and wherein the tracking token further associates the data payload with a validity condition comprising at least one of a start time, an end time, or a lifecycle state for the cryptographic key identifier;
store the tracking token in a tracking token database;
receive a request from the key management engine to encrypt the data payload based on a request from a first application servicer providing a first service;
scan the first application servicer to identify security attributes of the first application servicer; and
transmit a signal to the key management engine permitting the key management engine to encrypt the data payload for the first application servicer based on determining that the first application servicer fulfills the at least one conditional attribute defined by the data context policy included in the tracking token and that the validity condition is satisfied, wherein the cryptographic tracking engine queries the tracking token database and compares the at least one conditional attribute to the security attributes of the first application servicer to determine that the first application servicer fulfills the at least one conditional attribute; and
wherein the program code for the key management engine, when executed, will cause the processor to:
encrypt the data payload based on a response from the cryptographic tracking engine indicating the key management engine is permitted to encrypt the data payload.

2. The system of claim 1, wherein the program code for the cryptographic tracking engine, when executed, will cause the processor to:
receive a request from the first application servicer to transmit the data payload to a second application servicer providing a second service;
query the tracking token database to determine that a second tracking token is present in the tracking token database including a second data context policy for the second application servicer; and
permit the first application servicer to transmit the data payload to the second application servicer based on determining that the second application servicer fulfills the second data context policy.

3. The system of claim 1, wherein the program code for the cryptographic tracking engine, when executed, will cause the processor to:
receive a request from the first application servicer to transmit the data payload to a second application servicer providing a second service;
query the tracking token database to determine that a tracking token associated with the second application servicer is not present in the tracking token database; and
generate a second tracking token including a second data context policy, the second data context policy defining at least one conditional attribute for the second application servicer to interact with the data payload.

4. The system of claim 1, wherein the program code for the cryptographic tracking engine, when executed, will cause the processor to:
receive a request from the first application servicer to transmit the data payload to a second application servicer providing a second service;
query the tracking token database to determine that a second tracking token is present in the tracking token database including a second data context policy for the second application servicer; and
deny the request from the first application servicer to transmit the data payload to the second application servicer based on determining that the second application servicer does not fulfill the second data context policy.

5. The system of claim 4, wherein the program code for the cryptographic tracking engine, when executed, will cause the processor to:
detect a common vulnerability present within the second application servicer; and
suspend the second tracking token associated with the second application servicer based on detecting the common vulnerability.

6. The system of claim 5, wherein the program code for the cryptographic tracking engine, when executed, will cause the processor to:
receive a notification indicating the common vulnerability is not present within the second application servicer; and
update the second tracking token in the tracking token database to remove a suspension of the second tracking token.

7. The system of claim 5, wherein the program code for the cryptographic tracking engine, when executed, will cause the processor to detect the common vulnerability present within the second application servicer based on executing a vulnerability scan of the second application servicer.

8. The system of claim 1, wherein the at least one conditional attribute for an application servicer interacting with the data payload is based on a tagged data type for the data payload.

9. The system of claim 1, wherein the cryptographic tracking engine includes an intervention policy service and a key control policy service.

10. The system of claim 1, wherein the program code for the cryptographic tracking engine, when executed, will cause the processor to manage a lifecycle of a cryptographic key associated with the cryptographic key identifier stored in the tracking token.

11. A method for managing access to encrypted data, comprising:
tagging a data payload with a data classification and a data type;
initializing a tracking token data structure with a tracking token containing a data payload and a data context policy reference, wherein the data context policy reference indicates a data context policy defining at least one conditional attribute for an application servicer to interact with the data payload;
storing the tracking token in a tracking token database accessible by a key management engine;
receiving a request from a first application servicer to transmit the data payload to a second application servicer;
querying, by the key management engine, the tracking token database to determine that the second application servicer satisfies the data context policy; and
transmitting the data payload from the first application servicer to the second application servicer when the second application servicer satisfies the data context policy.

12. A system for managing access to encrypted data, the system comprising:
a key management server configured with program code for providing key management services;
an encrypted database; and
a processor coupled to the key management server, the processor configured with program code stored in memory for providing cryptographic tracking services, wherein the program code for the key management services, when executed, will cause the key management server to:
encrypt a data payload to generate an encrypted data payload; and
store the encrypted data payload in the encrypted database;
wherein the program code for the cryptographic tracking services, when executed, will cause the processor to:
receive a request for encrypted data from a first application servicer;
determine that the first application servicer fulfills at least one conditional attribute defined by a data context policy referenced in the tracking token; and
transmit a request to a decryption server requesting the decryption server to decrypt the encrypted data payload and transmit the data payload to the first application servicer.

13. The system of claim 12, wherein the data context policy referenced in the tracking token requires the first application servicer to communicate with the decryption server to access the encrypted data payload.

14. The system of claim 12, wherein the program code for the cryptographic tracking services, when executed, will cause the processor to prevent the first application servicer from transmitting decrypted data to a second application servicer when the first application servicer and the second application servicer do not fulfill at least one conditional attribute defined by the data context policy referenced in the tracking token.

15. The system of claim 12, wherein the data context policy includes plural conditional attributes for the first application servicer including at least conditional attributes relating to any one or more of:
a system attribute;
a service attribute;
an identity attribute; and
a session attribute;
wherein the at least one conditional attribute includes any one of:
an application identifier;
a timestamp corresponding to a time the request for encrypted data was received by the processor; and
a reason for the request for encrypted data.

16. The system of claim 12, wherein the tracking token issues the data context policy to the first application servicer, wherein the data context policy permits or denies the first application servicer to access encrypted data based on a state of the tracking token, the state of the tracking token including:
an initialized state;
an operational-ready state;
an operational-active state;
a suspended state; and
a terminated state.

17. The system of claim 16, wherein the program code for the cryptographic tracking services, when executed, will cause the processor to prevent the decryption server from decrypting the encrypted data payload when the tracking token is in the suspended state, wherein the suspended state indicates that the first application includes a Common Vulnerability and Exposure (CVE).

18. The system of claim 12, wherein the tracking token includes any one of alternative data structures including:
a certificate;
a digital signature;
a signed identifier;
single sign-on credentials;
ZPK attributes;
a signed configuration;
a Kerberos ticket; and
a digital contact trace,
wherein the data structure references the data context policy.

19. The system of claim 12, wherein the program code for the cryptographic tracking services, when executed, will cause the processor to perform data loss prevention (DLP) monitoring on the first application servicer and the encrypted data payload.

20. A system for detecting compromised encrypted data, the system comprising:
memory; and
a processor configured with program code stored in the memory for providing cryptographic tracking services, wherein the program code, when executed, will cause the processor to:
detect that a first application servicer has interacted with a data payload;
determine that the first application servicer is not issued a tracking token or that a data context policy referenced in an issued tracking token is not active, wherein the data context policy corresponds to the data payload; and
terminate a connection of the first application servicer to prohibit access to additional data payloads.
